(19) United States
(12) Patent Application Publication
(10) Pub. No.: US 2025/0052651 A1
(43) Pub. Date: Feb. 13, 2025

(54) INTEGRATED DEVICE FOR COMPREHENSIVE TISSUE TO SINGLE-CELL SAMPLE PREPARATION

(71) Applicant: Brown University, Providence, RI (US)

(72) Inventors: E. Celeste Welch, Providence, RI (US); Riley Renee Flores, West New York, NJ (US); Anubhav Tripathi, Northborough, MA (US)

(21) Appl. No.: 18/798,715

(22) Filed: Aug. 8, 2024

Related U.S. Application Data
(60) Provisional application No. 63/518,959, filed on Aug. 11, 2023.

(51) Int. Cl. G01N 1/31; B01L 3/00

(52) U.S. Cl. CPC G01N 1/31; B01L 3/502753; B01L 2200/027; B01L 2200/0647; B01L 2300/0645; B01L 2300/0681; B01L 2400/0436; B01L 2400/0487

(57) ABSTRACT

Described herein are methods and devices directed to preparing complex tissue samples for direct single cell analysis (e.g., scRNAseq) in a comprehensive, enzyme-free manner. The device and method use shear forces, mechanical features, electrical treatment, and acoustics, in addition to programmed microfluidic flow to dissociate a tissue sample into a purified suspension of single cells. In an example, a tissue sample is loaded into a well with retaining mesh on either side. A combination of microfluidic flow, shear, and electrical treatment elutes clumps (e.g., aggregates or agglomerates) of cells from this well, while a sample-specific, back and forth flow is repeated to begin an impurity removal process. At an outlet of the device, purified cells suitable for single cell analysis are eluted. As described herein, the device can be operated continuously.

### CROSS-REFERENCE TO RELATED APPLICATIONS

This application claims the benefit of priority to U.S. Provisional Patent No. 63/518,959, filed on 11 Aug. 2023, the entirety of which is incorporated by reference as if fully reproduced and set forth herein in its entirety.

### FIELD OF THE INVENTION

The embodiments of the present invention relate to methods and devices for tissue dissociation and, in particular, to dissociation of tissue samples into single cells and/or smaller groups of cells, with lower costs, chemical/enzyme-free, and providing faster speeds/ease of use, while maintaining cell viability and integrity during/after dissociation so that the cells can be subsequently analyzed and compared to other cells without delay.

### BACKGROUND OF THE INVENTION

Single cell transcriptomics examines the gene expression level of individual cells in a tissue or heterogeneous sample by simultaneously measuring nucleic acid concentration/composition, for example, the RNA concentration (e.g., mRNA), of hundreds to thousands of cells in parallel. Single cell transcriptomics promises to unravel heterogeneous cell populations and provide high-resolution, cellular data on tissue heterogeneity. Single cell analysis (SCA) is a field that measures the properties of individual cells, increasing the resolution of cellular data from a given tissue. For example, when applied to a tumorous tissue, knowledge of single cells (e.g., scRNAseq) from the tissue can provide enhanced data resolution on arising mutations or metastasis, guide treatment options, and help prognosis of a cancer patient. In this scenario, the detection of a rare cell can be the difference between life and death. SCA techniques have clearly emerged as the superior analytical tool in cancer and other diagnostic applications. However, tissues are complex adherent structures, and it is challenging to process complex tissues into viable, single cells, while retaining each cell's viability, integrity, and original transcriptional expression. Existing tissue dissociation methods, such as tissue homogenization, were created not for single cell analysis, but for downstream bulk sequencing. The lack of adequate sample preparation technologies for efficient SCA from tissue poses a major limitation for the advancement of SCA technology. Variations on traditional tissue dissociation techniques are time consuming, frequently involve numerous manual preparation steps, and are still antiquated. These tissue dissociation techniques often utilize a temperature-controlled chemical dissociating media and/or mechanical agitation (e.g., plate shaking, centrifugation, vortexing with a vortex device, pipetting). Traditional protocols can take hours to perform, and often involve countless pieces of expensive instrumentation, along with a variety of expensive reagents. Existing instruments can use chemicals/enzymes, be cost-prohibitive, use older liquid handling equipment, take too much time, and can also be difficult to adapt to different tissue types and sizes. Further, removing chemicals/enzymes from the single cells (or suspension thereof) can interfere with streamlining a method for sample preparation and SCA. What is urgently needed are new devices and methods for tissue dissociation into single cells and/or smaller groups of cells.

### BRIEF SUMMARY OF THE INVENTION

Example embodiments of the present invention provide devices and methods for preparing a complex tissue sample into single cells for direct single cell analysis (SCA). While the devices and methods disclosed herein are designed for provision of cells for SCA (e.g., for scRNAseq), the devices and methods can potentially be used for other purposes. For example, the devices and methods can be used for preparing single cell cultivation/isolation, for isolation of (non-organic) particles from larger masses, or for application of shear forces, along with other forces, to various particles for the purpose of disaggregation or separation, which may include isolation of organics from inorganics or other organics. The technology disclosed herein contemplates a variety of uses but provides an immediate benefit for improvement of SCA sample preparation workflows.

The present innovation, in one of its broadest embodiments (feature A), provides a device for preparing a complex tissue sample into single cells for direct single cell analysis (SCA), the device comprising: a pump capable of providing a back and forth flow including a forward flow and a reverse flow through the device, in combination with one or more mechanical features to provide shear forces (e.g., chambers, microfluidic channels, changes in liquid flow path), a tissue input well for holding the tissue sample, said well in fluid communication with an inlet comprising a first mesh and an outlet comprising a second mesh; wherein the first mesh is operative to retain the tissue sample in the well when a reverse flow is established from the outlet to the inlet, and the second mesh is operative to retain the tissue sample in the input well when a forward flow is established from the inlet to the outlet yet allow clumps of cells, cell aggregates, or single cells through the well's outlet; at least one microfluidic channel in fluid communication with the outlet with an optional third mesh disposed therein the microfluidic channel; an acoustic inlet in fluid communication with the at least one microfluidic channel, connected to a first acoustic region comprising a high frequency acoustic transducer operative to direct acoustic (sound) waves to clumps of cells in the acoustic region, which comprises a fourth mesh at a first acoustic outlet in fluid communication with a microchannel; and wherein the device is capable of receiving flow from a pump from the inlet to the outlet, then the pump repeatedly reverses, and flow is directed from the outlet to the inlet and vice versa, with a repeated back and forth flow through the device, thereby eluting purified single cells, suitable for SCA, from the microchannel of the acoustic outlet. Said acoustic outlet can be connected, for example, to tubing leading to immediate SCA. According to some aspects, the shear flow in the device is not caused by the fluid repeatedly reversing direction. The shear flow is produced by passage at a high flow rate through microchannels that are designed to sequentially increase the shear stress based on microchannel geometry itself (the channel size narrows sequentially). The backflow in the device is only used to ensure that the device does not clog and to ensure optimal processing and does not produce any additional shear force component. The overall net flow of cells in the device is forward, with small backflow steps to ensure that the meshes etc. do not clog.

In some embodiments, the device of feature A can be wherein the tissue input well comprises one or more electrodes including at least an electrode on a first side of the well and a ground on a second side of the well. The device can further comprise one or more additional acoustic inlets in fluid communication with the first acoustic region, to provide a series of acoustic regions, each capable of being configured with addition mechanical features (for shear forces/flow), mesh(es), microchannel(s), and second acoustic outlet(s) operative to apply additional acoustic (sound) waves to disaggregate clumps of cells.

An example of another unique feature of the device is that it requires no chemicals or enzymes, and the eluted single cells can be immediately analyzed without the requirement for additional preparation steps such as filtration, single cell selection, debris removal, or purification. Thus, the invention can provide a continuous operation, which is extremely valuable in industrial (e.g., or high throughput) settings. As such, the invention can be claimed as the device and consisting essentially of a liquid used for transport and single cells, without chemicals and/or enzymes; ready for downstream SCA processing; in a continuous system.

The devices disclosed herein can be configured wherein the second, third, fourth mesh, and any additional meshes are configured progressively smaller in mesh size, with the smallest mesh size at an outlet of the device allowing only single cells for SCA to elute from the device. In another example, the mesh can be all the same size, or other varying size combinations.

In some embodiments, the devices disclosed herein can be configured wherein at least one mesh is operative to allow passage other biological or material constituents in the size from about 1 nm to about 1 mm or of single cells/viruses/particles/proteins in the size from about 1 μm to about 1 mm. In some embodiments, the meshes are operative to purify the single cells for SCA due to the back and forth, forward flow and reverse flow through the device. In some embodiments, meshes are used for purification, depending on impurities present.

In some embodiments, the repeated back and forth flow is operative to prevent clogs in the device. In some embodiments, at least one microfluidic channel includes a change in diameter along a length of the channel, the change operative to provide additional mechanical or shear forces to disaggregate clumps of cells or other particles. In some embodiments, even during continuous operation, an unclogging step can be added at any point in a process. In an unclogging step, backflow or a chemical or enzyme flush can be used, but it is understood these are not retained in the device/method after operation is resumed.

In some embodiments, the device can be configured wherein an acoustic transducer is operative to provide acoustic (sound) waves in the range from about 40 kHz to about 20 MHz, in the range from about 500 kHz to about 10 MHz, in the range from about 1 MHz to about 8 MHZ, or in the range from about 3 MHz to about 7 MHz. In some embodiments, an acoustic transducer is operative to provide an acoustic (sound) wave at about 5.7 MHz. In some embodiments, the acoustic waves are programmed to emit at the resonant frequency of the transducers.

In some embodiments, at least one mesh comprises a polymer. In some embodiments, the polymer includes nylon. In some embodiments, at least one mesh comprises a metal or another material.

In some embodiments, the tissue input well comprises a width in the range from about 100 nm to about 50 mm, from about 500 nm to about 25 mm, from about 1 mm to about 10 mm, from about 1 mm to about 5 mm, or from about 1.5 mm to about 3 mm. In some embodiments, the tissue input well can include a height in the range from about 100 nm to about 5 cm, from about 500 nm to about 1 cm, or about 2 mm to about 100 mm. In some embodiments, the tissue input well can be configured as a continuous inlet for tissue(s).

In some embodiments, a device disclosed herein comprises a pair or other number of electrodes, wherein the electrodes are capable of providing an electric field through a tissue sample, the electrical field comprising a voltage, current, frequency, field, or a combination thereof. The pair can be more than one pair (e.g., a series).

In some embodiments, the electrical field comprises a DC field, an AC field, a magnetic field, an electromagnetic radiation of any wavelength, a particle, or a combination thereof. In some embodiments, the electrical field comprises about a 20 V, about 1 kHz square wave.

The devices disclosed herein can be operated with the proviso wherein the device is enzyme-free, chemical free, and/or additive free. The unclogging step can be done with no residual trace left after the unclogging or without the use of any enzymes whatsoever.

In some embodiments, the devices disclosed herein can be claimed with cells disposed inside and the device delivering into single cells for SCA, wherein the plurality of purified single cells are >70% viable. In some embodiments, the devices disclosed herein are suitable for providing continuous operation. In some embodiments, the devices disclosed herein are capable of removing red blood cells (and/or cell fragments) from the plurality of purified single cells.

In some embodiments, any one of the devices disclosed herein can be wherein the device is capable of disaggregating cell clumps, purifying the resulting cell suspension, and eluting a plurality of purified single cells suitable for direct analysis via SCS.

In some embodiments, any one of the devices disclosed herein can be wherein the device is capable of providing the plurality of purified single cells in about 1 to about 120 minutes, in about 2 to about 60 minutes, in about 3 to about 30 minutes, or in about 5 to about 20 minutes.

In some embodiments, any one of the devices disclosed herein can be configured wherein the device comprises a base layer, a channel layer, a polydimethylsiloxane (PDMS) layer, and a cover layer; or wherein the device is produced in layers. In the alternative, a monolithic device can be 3D-printed. In some embodiments, the device is assembled from small components.

In some embodiments, any one of the devices disclosed herein can be wherein a high frequency acoustic transducer is disposed on a cover layer outside a first acoustic region. In some embodiments, the transducers are placed on the outside of a PDMS layer/cover layer.

In some embodiments, any one of the devices disclosed herein can be with a non-ionic liquid disposed inside. An example of a non-ionic liquid is 18 megaohm water, but in general pure water can be a non-ionic liquid. In some embodiments, the non-ionic liquid can be a fluid than can include one or more non-ionic liquids and/or additives. In an example, the non-ionic fluid can be ultra-pure H₂O supplemented with isotonic sucrose solution.

In some embodiments, any one of the devices disclosed herein can be further comprising an imaging device operative to form a (visual) image of at least one of a cell, tissue, cell clump, or a flow. In some embodiments, a device herein can be combined with an impedance sensor in order to assess performance in real time. This is another way to validate the performance of the device.

In some embodiments, a method (feature B) for preparing a complex tissue sample into single cells for direct single cell analysis (SCA) is disclosed herein, the method comprising the steps of: 1) obtaining a device of any preceding or following feature; 2) disposing a tissue sample into the tissue input well; 3) providing a back and forth liquid flow including mechanical forces and a forward flow and a reverse flow through the device; whereby the device receives flow from the pump from the inlet to the outlet, then the pump repeatedly reverses, and flow is directed, in sum, from the inlet to the outlet, causing a shear liquid flow as the liquid traverses the channel geometry; 4) establishing an acoustic (sound) energy in the device and at least one of a liquid flow through the device and an electrical field in the device, thereby eluting purified single cells, suitable for SCA, from the microchannel of the outlet.

In some embodiments, the method can be wherein an electrical field is applied in the tissue input well. In some embodiments, the method can be wherein one or more additional acoustic in fluid communication with the first acoustic region and are utilized to provide a series of acoustic regions, operative to apply progressive acoustic (sound) energy to clumps of cells.

In some embodiments, the method can be wherein the second, third, fourth mesh, and additional meshes are configured progressively smaller in mesh size, with the smallest mesh size at an outlet of the device, whereby only single cells for SCA elute from the smallest mesh size/device.

In some embodiments, the method can be wherein the meshes of the same sizes are used, whereby only single cells for SCA elute from the smallest mesh size/device. In some embodiments, a single sized mesh or multiple meshes of the same size can be utilized, not a smaller mesh at the inlet.

In some embodiments, the method can be wherein mesh is utilized with the back and forth, forward flow and reverse flow through the device, to purify single cells for SCA.

In some embodiments, the method can be further comprising the step of preventing clogs in the device by using a repeated back and forth flow.

In some embodiments, the method can be further comprising the step of applying at least one additional shear force to a clump of cells, wherein the step includes a change in diameter along a length of microchannel or increasing the fluid flow rate, the change operative to provide additional shear forces to clumps of cells.

In some embodiments, the method can be wherein acoustic (sound) waves are applied in the range from about 40 kHz to about 20 MHz, in the range from about 500 kHz to about 10 MHz, in the range from about 1 MHz to about 8 MHz, or in the range from about 3 MHz to about 7 MHz.

In some embodiments, the method can be wherein acoustic (sound) waves are applied at about 5.7 MHz. In some embodiments, the method can be wherein at least one mesh comprises a polymer, a filter, a membrane, a screen, or a combination thereof. In some embodiments, the method can be wherein the polymer includes nylon.

In some embodiments, the method can be wherein the tissue sample comprises a width in the range from about about 100 mm to about 10 cm, from about 100 mm to about 1 cm, from about 100 nm to about 50 mm, from about 500 nm to about 25 mm, from about 1 mm to about 10 mm, from about 1 mm to about 5 mm, or from about 1.5 mm to about 3 mm.

In some embodiments, the method can be wherein the method comprises applying an electric field through the tissue sample, the electrical field comprising a voltage, current, frequency, field, or a combination thereof. In some embodiments, the method can be wherein the electrical field comprises a DC field, an AC field, a magnetic field, an electromagnetic radiation of any wavelength, a particle, or a combination thereof.

In some embodiments, the method can be wherein the electrical field comprises about a 20 V, about 1 kHz square wave.

In some embodiments, the method can be wherein the method is performed continuously and is capable of providing a continuous operation.

In some embodiments, the method can be wherein the method is sufficient to remove red blood cells (and/or digested extracellular matrix fragments/non-cellular components) from a plurality of purified single cells.

In some embodiments, the method can be wherein the method is capable of providing disaggregated cell clumps, purifying the resulting cell suspension, and eluting a plurality of purified single cells suitable for direct analysis via SCS;

In some embodiments, the method can be wherein the method is tissue and/or cell specific, using a program developed for a specific tissue and/or cell type; and in some embodiments, the method can be wherein the method is capable of providing the plurality of purified single cells in about 1 to about 120 minutes, in about 2 to about 60 minutes, in about 3 to about 30 minutes, or in about 5 to about 20 minutes.

In some embodiments, the method can be further comprising use of an imaging device operative to form a (visual) image of at least one of a cell, tissue, cell clump, or a flow. In some embodiments, the method can be further comprising use of a sensor device operative to form a (electrical) reading of at least one of a cell, tissue, cell clump, or a flow.

In some embodiments, a method for diagnosing a condition in a subject in need thereof is disclosed herein, the diagnostic method comprising the method of any one of the features herein; wherein: (1) a candidate tissue sample is provided from the subject; (2) cells suitable for SCS are provided by the methods herein; (3) analyzing/detecting at least a single cell from the subject, said single cell indicative of the condition; and (4) reporting a cell type of the single cell. In some embodiments, the diagnostic method can be wherein the analyzing comprises single cell transcriptomics, DNA or RNA sequencing (RNA-seq), nucleic acid amplification and analysis, flow cytometry, microscopy, flow cytometry and fluorescence activated cell sorting (FACS), metabolomic or other chemical analysis, clustering, isolation of the cell or nuclei, further application of a flowing force, cell culture, any other analytical technique, or a combination thereof.

In some embodiments, the diagnostic method can be wherein the candidate tissue is derived from a cancerous tissue, an abnormal tissue, or a tissue infected with a microorganism/virus.

In some embodiments, any of the methods disclosed herein can be executed wherein a tissue-specific, condition-specific, cell-specific, or subject-specific program is utilized in the method.

In some embodiments, a method for designing, screening, and/or locating a therapeutic agent is disclosed herein, said therapeutic agent suitable for preventing and/or treating a subject either in need or for prophylactic treatment. The screening method can be wherein the method is repeated for a plurality of candidate therapeutic agents and a measurement/determination of antagonism or agonism of a receptor of is provided for each of the candidate therapeutic agents. Each of the candidate therapeutic agents can be ranked in comparison to the other each of the candidate therapeutic agents for an efficacy.

It is contemplated that the above-described methods can optionally include administering and/or applying a therapeutic agent to a subject or in vitro (lab) use. The therapeutic agent can have a potency in any range suitable to provide an effect in a subject in need thereof. The effect can be immediate and readily discernable, for example, by a decrease in symptoms, conditions, or injuries. The effect can be a long-term effect that requires years and/or a statistical significance to discern. The therapeutic agent can be administered in combination with any other drug or therapeutic agent and can have efficacy in the prevention, modulation, treatment, and/or diagnosis. The present invention can be utilized to design therapeutic agents to perform the methods disclosed herein. The therapeutic agents can be delivered alone or can be linked to other agents (e.g., antibody conjugates, liposome formulations, inhaled particles, time-released formulations, micro/nanoparticles). In some embodiments, a targeting moiety can be utilized with the therapeutic agents. In some embodiments, the targeting moiety is an antibody with affinity for a specific type of cell (e.g., a specific type of connective tissue). In another example, the targeting moiety is a nanoparticle. In some embodiments, a formulation or a therapeutic agent can be administered directly to a tissue in need thereof, for example, when an acute injury is treated, by use of a topical (skin penetrating) formulation, or in an emergency. In some embodiments, the device can be used to study cellular heterogeneity. The methods disclosed herein can be utilized to diagnose subjects' risk of being in need of a treatment. The methods can be applied to populations, for example, with artificial intelligence and machine learning, or can be applied to individuals, for example, using personalized medicine.

While the summary examples disclosed above provide some embodiments of the invention, other implementations are also contemplated, described, and recited herein.

### BRIEF DESCRIPTION OF THE DRAWINGS

For the purpose of illustration, certain discernable embodiments of the present invention are shown in the drawings described below. It should be understood, however, that the invention is not limited to the precise arrangements, data, dimensions, and illustrations shown. In the drawings:

FIG. 1A and FIG. 1B provide example purposes and concepts of cellular disaggregation (e.g., cells from tissues) and traditional methods used. FIG. 1A provides an illustration of cell spheroids or cell aggregates at left. The tissues, spheroids or aggregates are forced through the device at a high flow rate, therefore generating a high shear stress, enabling the samples to be processed into a single cell suspension. If desired, the single cells can then be isolated, for example, by flowing the suspension into a micropipetting/lysis device. Then, at right, SCA is performed in the example of single cell sequencing and analysis. FIG. 1B shows, at left, manual repeated pipetting that is traditionally used for cellular disaggregation; and, at right, recent advances such as automated repeated pipetting using, for example, a series pipetting in a liquid handling robot.

FIG. 2A provides overview diagrams introducing devices of the presently disclosed technology. FIG. 2A shows a device 70 for preparing a complex tissue sample into single cells for direct single cell analysis. The device 70 is in fluid communication with a pump 65 at an inlet 20 and at an outlet 85. In this example, the pump 65 is in communication with a computer/processor 900 (for sample-specific programming) and an optional visualization/sensor/characterization/morphology system 800 is illustrated over the device 70.

FIG. 2B shows an enlarged schematic view of a configuration of mechanical features/shear forces/microfluidic flow channels that 100 that provide shear flow, transport, and purification. The channel dimensions shown in FIG. 2B can be changed and the orientation of the channels can be changed to provide additional mechanical features/shear forces or to confer additional benefits in terms of sample separation or purification. Multiple channels for parallel processing are also tested in the device, but a single channel is effective and has a higher (cell) recovery.

FIG. 3 provides a perspective view of an Integrated Device 200 of the present technology. A computer with sample-specific programming 900 can be utilized with the pump 65, device 200, or a visualization/sensor/characterization/morphology system 800. Pump 65 delivers shear flow through inlet tubing 215 to inlet 220, while a tissue sample is in well 230 and retained by mesh (201, 202) on either side of the well. Filtering and disaggregating of clumps of cells and cells is accomplished by further shear flow, mesh, and application of additional forces (such as acoustics) as described in more detail in the Detailed Description of the Invention below.

FIG. 4 provides an expanded diagram of an Integrated Device 300 of the present disclosure. In this example, a glass bottom layer is at base, an acrylic channel layer is shown with microchannels and meshes, a PDMS (polydimethylsiloxane) is shown with example dimensions, and an acrylic cover layer is illustrated. Different numbers of layers can be used, different materials can be used, or a megalithic structure can be fabricated to practice the invention. It is understood that the layers and materials are for illustration of the inventive concept as it is readily contemplated that a variety such materials and constructs such as opaque cover layers, bottom (glass) layers, polymeric or silica materials can be utilized to practice the invention disclosed herein.

FIG. 5 provides a perspective view of another embodiment of an Integrated Device.

FIG. 6A and FIG. 6B provide perspective views of Integrated Devices capable of providing the methods disclosed herein. FIG. 6A shows a representative image of a serially configured device. FIG. 6B shows a top view image of a serially configured device.

FIG. 7 provides an expanded view of an Integrated Device to illustrate a tissue input well construct 233 that can take various sizes or can be configured as a tissue inlet for a continuous operation (e.g., continuous feed).

FIG. 8 provides a flow diagram illustrating an example method of the present invention.

FIG. 9 shows a photo of a prototype integrated device 700 with waveform generator 260 and pump 65.

FIG. 10A and FIG. 10B show comparative data from single cell preparation from tissue using an integrated device of the present disclosure and a commercial device. FIG. 10A shows a comparative plot for Viability (%) for mouse liver. FIG. 10B shows a comparative plot for cell count/gram of tissue (weight adjusted cell counts).

FIG. 11A illustrates, in a flowchart, the use of a pump to provide back and forth liquid flow for single-cell preparation.

FIG. 11B illustrates, in a flowchart, the retention of a tissue sample in a well using meshes during forward and reverse flows.

FIG. 11C illustrates, in a flowchart, the passage of cell clumps through microfluidic channels to the acoustic cell dissociation system.

FIG. 11D illustrates, in a flowchart, the use of acoustic waves to break down cell clumps into single cells.

### DETAILED DESCRIPTION OF THE INVENTION

The subject innovation is now described, in some examples with reference to the drawings, wherein examples can used to refer to the aspects of the breadth of concepts of the invention. In the following description, for purposes of explanation, specific details are set forth in order to provide a thorough understanding of the present invention. It may be evident, however, that the present invention may be practiced without these specific details. It is to be appreciated that certain aspects, modes, embodiments, variations and features of the invention are described below in various levels of detail in order to provide a substantial understanding of the present invention.

### Definitions

For convenience, the meaning of some terms and phrases used in the specification, examples, and appended claims, are provided below. Unless stated otherwise, or implicit from context, the following terms and phrases include the meanings provided below. The definitions are provided to aid in describing particular embodiments, and are not intended to limit the claimed invention, because the scope of the invention can be determined by the claims. Unless otherwise defined, all technical and scientific terms used herein have the same meaning as commonly understood by one of ordinary skill in the art to which this invention belongs. If there is an apparent discrepancy between the usage of a term in the art and its definition provided herein, the definition provided within the specification shall prevail.

As used in this specification and the appended claims, the singular forms “a,” “an” and “the” include plural referents unless the content clearly dictates otherwise. For example, reference to “a cell” includes a combination of two or more cells, and the like.

As used herein, the term “approximately” or “about” in reference to a value or parameter are generally taken to include numbers that fall within a range of 5%, 10%, 15%, or 20% in either direction (greater than or less than) of the number unless otherwise stated or otherwise evident from the context (except where such number would be less than 0% or exceed 100% of a possible value). As used herein, reference to “approximately” or “about” a value or parameter includes (and describes) embodiments that are directed to that value or parameter. For example, description referring to “about X” includes description of “X”.

As used herein, the term “or” means “and/or.” The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, a “continuous operation” can be provided by the devices and/or methods. A continuous operation refers to preparation of single cells for a continuous time period of about 4 hours, about 8 hours, about 16 hours, about 24 hours, about a week, about a month, or about 3 months. As described herein, the devices and methods are capable of providing purified single cells in about 1 to about 120 minutes, in about 2 to about 60 minutes, in about 3 to about 30 minutes, or in about 5 to about 20 minutes. In a continuous operation mode, purified single cells are provided in these time ranges after loading in the tissue input well or after loading via a fully-automated continuous operation process. In some embodiments, any of the devices disclosed herein can be fully automated. This can be a continuation of the continuous operation, for example, the device or method is fully automated and therefore has no manual preparation steps, no other required pieces of equipment, or other user intervention required.

As used herein, a “range” may be provided. A statement may include “in the range from about A to about B”. It is clear herein that all points from A to B are subsumed by the range, and all those points can define preferred ranges. Within said range, any range subsumed therein means any range that is within the stated range. Endpoints within the range can define a new range. For example, the following are all subsumed within the range of about 10 to about 50. 10 to 20; 15 to 35; 23 to 40; or 50 to 31; or any other range or set of ranges within the stated range. As such, within the range any set of endpoints subsumed therein can be used as an exemplary range. Importantly, when a range is defined as “critical” herein, no value or range that is deemed “close enough” but not falling at or within said “critical range” is sufficient to practice the present invention.

As used herein, the term “comprising” means that other elements can also be present in addition to the defined elements presented. The use of “comprising” indicates inclusion rather than limitation.

The term “consisting of” refers to compositions, methods, and respective components thereof as described herein, which are exclusive of any element not recited in that description of the embodiment.

As used herein the term “consisting essentially of” refers to those elements required for a given embodiment. The term permits the presence of additional elements that do not materially affect the basic and novel or functional characteristic(s) of that embodiment of the invention. In specific examples, “consisting essentially of” can be explained herein for each example or can be defined broadly, for example, by stating that a device or a method (in a method herein) does not include any other component or step(s) in addition to the ones specified. The term “consisting essentially of” can be clarified in a claim using commonly understood language. For example, the technology disclosed herein can be claimed to consist essentially of a device with a liquid or non-ionic liquid inside, said liquid consisting essentially of a liquid without chemical or enzymatic buffers for dissociation of tissues (into cells). In this example, the addition of a chemical or enzymatic buffer to the liquid would not teach or suggest the present invention because a critical aspect of this technology is providing single cells ready for analysis, without requiring removal of chemicals or enzymes (as such, the devices and methods can be powerfully applied to continuous operations). At all places herein single cells are discussed (e.g., the technology provides single cells for SCA), and it should be noted that a suspension of single cells is provided including purified single cells suitable for SCA (e.g., viable and healthy single cells).

The term “statistically significant” or “significantly” refers to statistical significance and generally means a two-standard deviation (2SD) or greater difference.

As used herein, the term “subject” refers to an animal, including but not limited to a dog, cat, horse, cow, pig, sheep, goat, chicken, rodent, or primate. Subjects can be house pets (e.g., dogs, cats), agricultural stock animals (e.g., cows, horses, pigs, chickens, etc.), racing mammals, laboratory animals (e.g., mice, rats, rabbits, etc.), but are not so limited. Subjects include human subjects. The human subject may be a pediatric, adult, or a geriatric subject. The human subject may be of either sex. In another example, the term “subject” can refer to a connective tissue culture, and the methods disclosed herein, while claimed towards subjects, contemplate use in the laboratory in synthetic tissue(s). While the term “subject” can be utilized in the claims, it should be clear to a person of ordinary skill that the devices and methods can be utilized for microorganisms, plants, non-living objects, or analytical methods in general.

As used herein, the term “aggregate” means a material or structure formed from a loosely compacted mass of fragments, cells, or particles; and the whole aggregate can be formed by combining several disparate elements or any combination of disparate and the same elements. As used herein, the term “agglomerate” means an assembly of particles, fragments, or cells rigidly joined together as by partial fusion, sintering or by growing together. In the spirit of the invention, the terms “clumps”, “aggregates”, and “agglomerates” can be used interchangeably herein to describe the spirit and advancement of the inventive concepts herein.

As used herein, a “shear liquid flow” refers to a liquid flow that includes forces on clumps in the liquid resulting from a shear force exerted by passage through the channel itself and specific channel geometry, causing shearing deformation of the clumps sufficient to at least partially break the clumps down into single cells.

As used herein, the terms “effective amount” and “therapeutically effective amount” include an amount sufficient to modulate a treatment or prevent or ameliorate a manifestation of disease or medical condition. Such a condition may not be readily discernable and may take years, statistical analysis, and/or machine learning to determine a prevention, treatment, or amelioration. It will be appreciated that there will be many ways known in the art to determine the effective amount for a given application. For example, pharmacological methods for dosage determination may be used in the therapeutic context. In the context of therapeutic or prophylactic applications, the amount of a composition administered to the subject will depend on the type and severity of the condition and on the characteristics of the individual, such as general health, age, sex, body weight and tolerance to drugs. It will also depend on the degree, severity and type of condition. The skilled artisan will be able to determine appropriate dosages depending on these and other factors. Any compositions disclosed herein can also be administered in combination with one or more additional therapeutic compounds. The devices and methods disclosed herein can be used prophylactically.

As used herein, the terms “treat,” “treatment,” “treating,” or “amelioration” when used in reference to a disease, disorder or medical condition, refer to therapeutic treatments for a condition, wherein the object is to reverse, alleviate, ameliorate, inhibit, manage, modulate, slow down or stop the progression or severity of a symptom or condition. The term “treating” includes reducing or alleviating at least one adverse effect (undesirable characteristic) or symptom of a condition. Treatment is generally “effective” if one or more symptoms or clinical markers are reduced. Alternatively, treatment is “effective” if the progression of a condition is reduced or halted. That is, “treatment” includes not just the improvement of symptoms or markers, but also a cessation or at least slowing of progress or worsening of symptoms that would be expected in the absence of treatment. Beneficial or desired clinical results include, but are not limited to, alleviation of one or more symptom(s), diminishment of extent of the deficit, stabilized (i.e., not worsening) state of a condition or decay, delay or slowing of a progression and/or risk of injury, and an increased lifespan/enjoyment as compared to that expected in the absence of treatment.

As used herein, the term “long-term” administration can be applied in vitro or in vivo and means that a therapeutic agent or drug is administered for a period of at least 12 weeks. The therapeutic agent or drug may refer to a formulation, composition, or agent. The formulation can be changed to a fresh formulation during administration. This includes that the therapeutic agent or drug is administered such that it is effective over, or for, a period of at least 12 weeks and does not necessarily imply that the administration itself takes place for 12 weeks, e.g., if sustained release compositions or long-acting therapeutic agent or drug is used. Thus, the subject (or tissue in case of lab experiment) is treated for a period of at least 12 weeks. In many cases, long-term administration is for at least 4, 5, 6, 7, 8, 9 months or more, or for at least 1, 2, 3, 5, 7 or 10 years, or more.

The methods and devices disclosed herein can be used in series, in combination, or simultaneously with administration of a composition (e.g., visualization agent and/or therapeutic agent). The administration of the compositions contemplated herein may be carried out in any convenient manner, including by any technique known in the art that is subsequently applied to a subject, topical application, absorption, injection, ingestion, transfusion, implantation or transplantation. In an example embodiment, compositions are applied as a tablet or drug in capsule. Any of the administration terms discussed herein can be used in vitro. The phrases “parenteral administration” and “administered parenterally” as used herein refers to modes of administration other than enteral and topical administration, usually by injection, and includes, without limitation, intravascular, intravenous, intramuscular, intraarterial, intrathecal, intracapsular, intraorbital, intratumoral, intracardiac, intradermal, intraperitoneal, transtracheal, subcutaneous, subdermal, subcuticular, intraarticular, subcapsular, subarachnoid, intraspinal and intrasternal injection and infusion. It is known in the art that therapeutic agents can be rapidly deployed through the skin and directly into joint/ligaments by use of DMSO (dimethyl sulfoxide) as a carrier solvent applied (with the therapeutic agent) to the skin near to or surrounding a joint. While DMSO is rarely used anymore for these purposes because of its nature as a universal solvent and its tendency to carry any residual chemicals present on the skin into the bloodstream (along with the intended agent), the technology contemplates such uses during formulation development and pre-clinical trials. In one contemplated embodiment, the compositions contemplated herein are administered to a subject by direct injection into a tissue, lymph node, or site of treatment. In another example, administration is provided in the form of a natural product, vitamin, supplement, food, aerosol, inhalation, vapor, or drink. Formulations disclosed herein can be ready made or require mixing just before administration.

Any of the methods disclosed herein can be carried out in part or completely by including a dietary change, a food, natural product, precursor, or prodrug of a therapeutic agent. As used herein, a precursor or a prodrug is intended to encompass compounds or therapeutic agents which, under physiologic conditions, are converted into the therapeutically active agents of the present invention (e.g., a compound for present claim 1). A common method for making a prodrug is to include one or more selected moieties which are hydrolyzed under physiologic conditions to reveal the desired molecule. In other embodiments, the prodrug is converted by an enzymatic activity of the host subject. For example, esters or carbonates (e.g., esters or carbonates of alcohols or carboxylic acids) are preferred prodrugs of the present invention. In certain embodiments, a chemical discussed in relation to this technology can be a prodrug, for example, wherein a hydroxyl in the parent compound is presented as an ester or a carbonate or carboxylic acid present in the parent compound is presented as an ester. A common method of making a precursor/prodrug that can be used herein is to use a carrier/nanocarrier (e.g., mesoporous silica particles). The precursor/prodrug can be released from a carrier to form the active therapeutic agent. A precursor or prodrug can be metabolized to the active parent compound (therapeutic agent) in vivo (e.g., the ester is hydrolyzed to the corresponding hydroxyl, or carboxylic acid).

The terms: “decrease”, “reduced”, “reduction”, or “inhibit” are all used herein to mean a decrease by a statistically significant amount. In some embodiments, “reduce,” “reduction” or “decrease” or “inhibit” typically means a decrease by at least 10% as compared to a reference level (e.g., the absence of a given treatment or agent) and can include, for example, a decrease by at least about 10%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, at least about 99%, or more. As used herein, “reduction” or “inhibition” does not encompass a complete inhibition or reduction as compared to a reference level. “Complete inhibition” is a 100% inhibition as compared to a reference level. A decrease can be preferably down to a level accepted as within the range of normal for an individual without a given disorder.

The terms: “increased”, “increase”, “enhance”, or “activate” are all used herein to mean an increase by a statically significant amount. In some embodiments, the terms “increased”, “increase”, “enhance”, or “activate” can mean an increase of at least 10% as compared to a reference level, for example an increase of at least about 20%, or at least about 30%, or at least about 40%, or at least about 50%, or at least about 60%, or at least about 70%, or at least about 80%, or at least about 90% or up to and including a 100% increase or any increase between 10-100% as compared to a reference level, or at least about a 2-fold, or at least about a 3-fold, or at least about a 4-fold, or at least about a 5-fold or at least about a 10-fold increase, or any increase between 2-fold and 10-fold or greater as compared to a reference level. In the context of a marker or symptom, a “increase” is a statistically significant increase in such level.

As used herein, the term: “small molecule” refers to a molecule that has a molecular weight <1000. As used herein, the term: “large molecule” refers to a molecule that has a molecular weight >1000, and the term includes biologics such as the examples of oligonucleotides, peptides, antibodies, linkers, oligosaccharides, polymers, DNA chains, and RNA chains. The term: “therapeutic agent” may refer to small molecule, element, large molecule, biologic, formulation, composition, agent, or a combination thereof.

### Integrated Device for Comprehensive Tissue to Single-Cell Sample Preparation

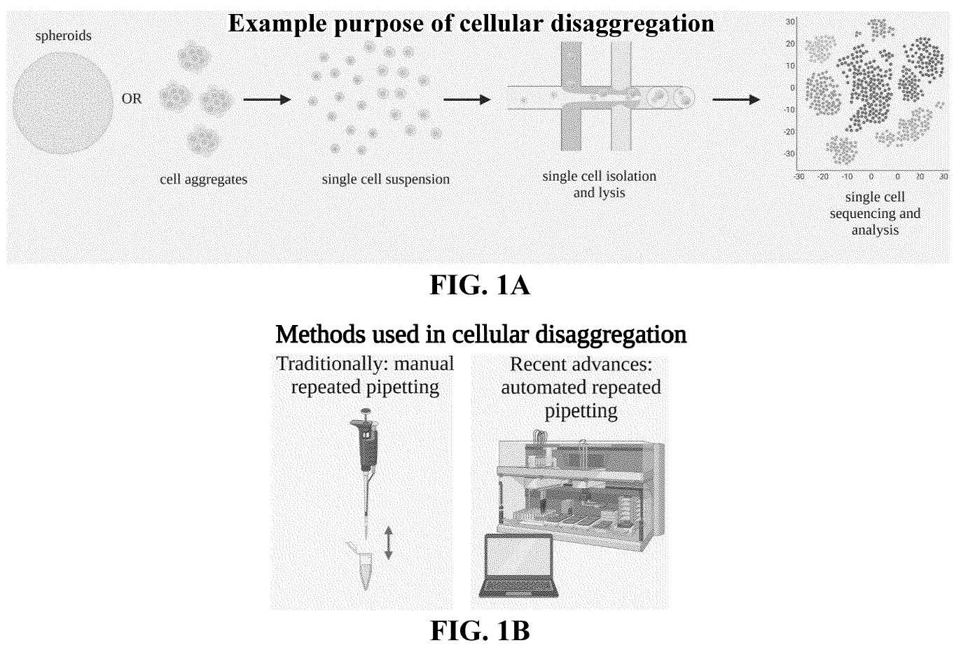

As the concepts for single cell isolation analysis and single cell transcriptomics have advanced, the sample preparation required to practice the single cell concepts needs to advance. Disclosed herein is the first device that is capable of preparing complex tissue samples for direct single cell analysis (e.g., scRNAseq) in a comprehensive and automated manner. As a background, FIG. 1A shows an illustration of cell spheroids or cell aggregates (left) separated into a single cell suspension (center), which is subjected to a single cell isolation and lysis for single cell sequencing and analysis (right). The devices and methods disclosed herein can be utilized for other technologies but are particularly novel and useful for providing single cell isolation from a tissue. Past methods are illustrated in FIG. 1B. As seen in FIG. 1B (e.g., pipetting), these past methods are antiquated. The present technology will now be described in view of mechanical forces, shear forces/flows, acoustic forces, electrical forces, and intelligent purification/operation.

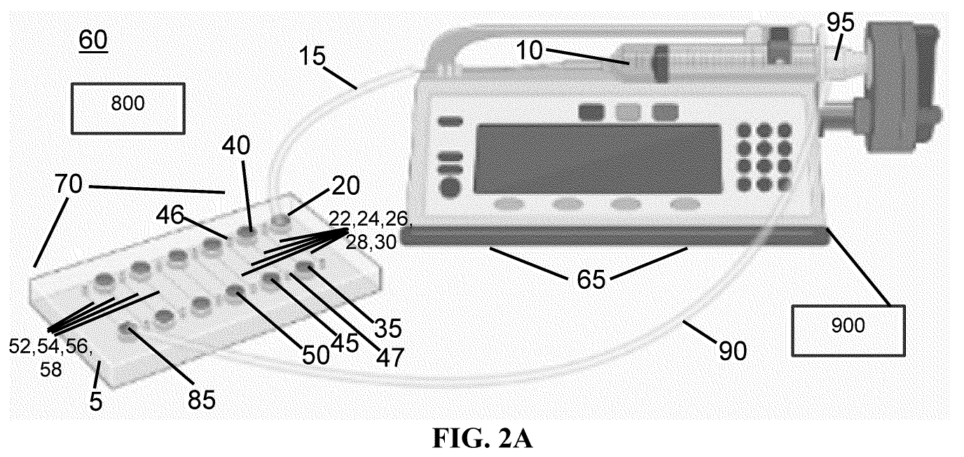

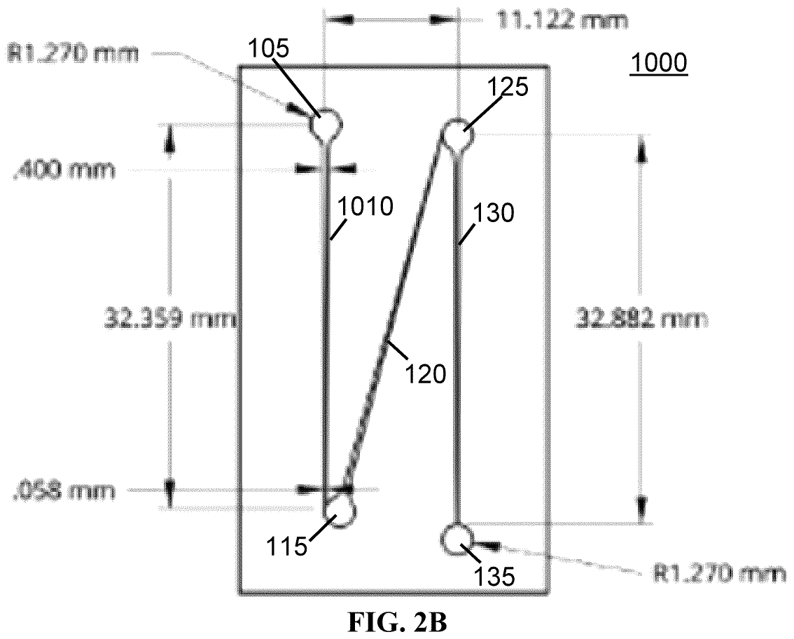

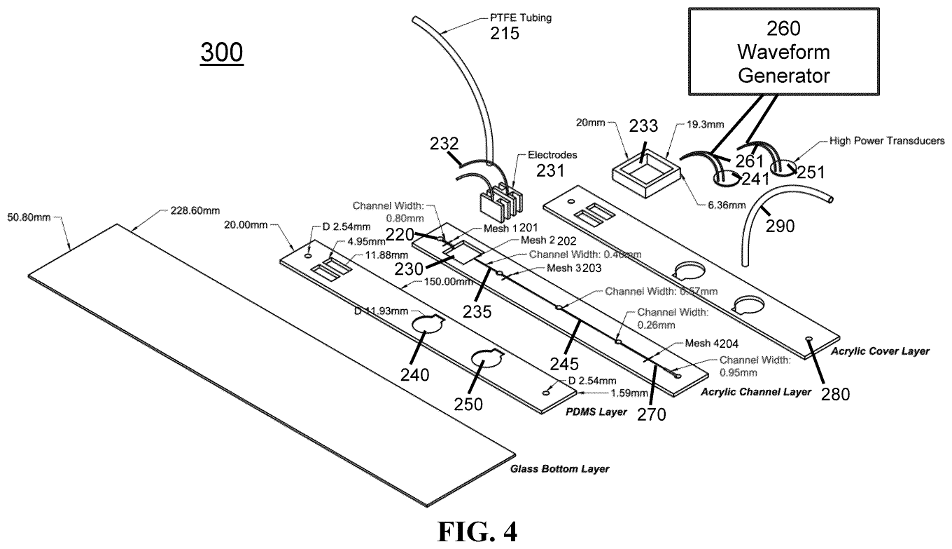

Various prototypes and embodiments were tested (see Examples). In some embodiments, an Integrated Device 60 of the present invention is shown in FIG. 2A. The device 60 includes an optional computer 900 and optional visualization/sensor/characterization/morphology unit 800. A pump 65 can include a fluid reservoir 10 and an inlet tube 15 for delivery of a fluid to the device 70 at an inlet 20. The device 70 can be provided on a base or substrate 5 that can include multiple layers (FIG. 4). The inlet 20 can be utilized as a tissue input well, which is described in varieties of more detail below. The pump(s) 65 can deliver flow, which causes shear forces on the tissue, and the tissue is held in the input well by mesh on both sides. It should be understood that the shear forces can be sample-specific and controlled by a program executed by the computer 900. Such a sample-specific program can undergo dynamic changes/modifications to the program of operation during operation using an active feedback system integrated with visualization/sensor/characterization/morphology unit 800. In any of the figures and embodiments disclosed herein, the computer 900 can include electrical connections (digital and/or analog), WiFi connections, fluidic, mechanical, or electromagnetic connection(s) to any other devices disclosed herein but these are not always illustrated in the figures due to complexity.

The back and forth flow has a net sum of forward flow from inlet 20 to outlet 85. Clumps of cells, some single cells, and impurities (e.g., cell fragments, red blood cells) can be present (or arise) at the tissue input well. These travel, with back and forth flow, along microfluidic channels 22, 24, 26, 28, 30 (the number of channels is optional) passing through meshes 47 and 46 and arriving at acoustofluidic regions 40 and 45. The number of meshes used can be varied as well and additional optional acoustofluidic regions (e.g., 35, 50) can be utilized. Additional microfluidic flow channels 52, 54, 56, 58 can be implemented. In this example, a single cell receiving chamber 95 is at the pump 65 and connected to an outlet tube 90, which is in fluid communication with an outlet 85 of the device 70. It should be understood that a smaller size mesh at the outlet 85 can be used to allow passage of single cells to the outlet tube 90 and into receiving chamber 95. The back and forth flow providing during the sample preparation causes impurities to be separated (e.g., retained by the various meshes inside 70) from the desirable single cells. Different combinations of mesh sizes in different locations can also be utilized, depending on the particular application of use.

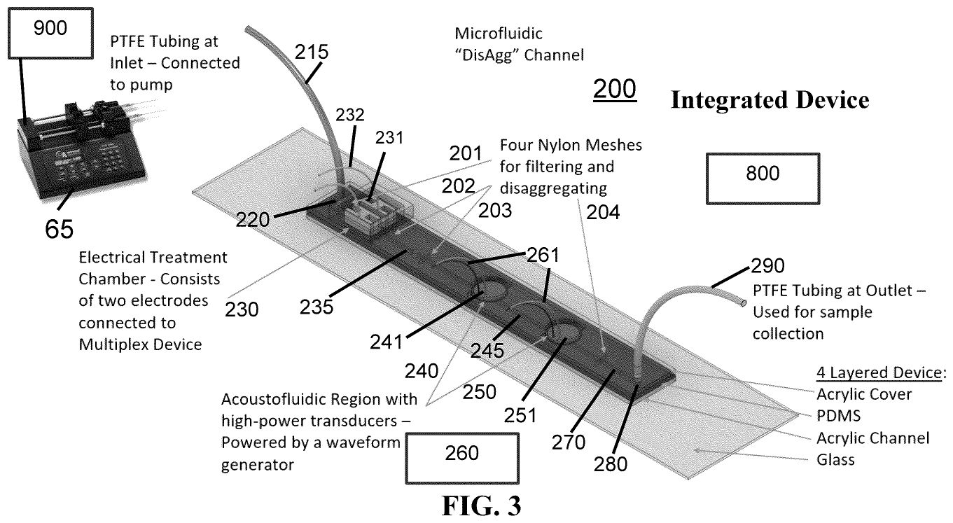

It is notable that the function of the mesh or nylon mesh in the presently disclosed device is merely for filtration, while physical mechanisms are designed to provide mechanical forces, and/or shear forces for the purpose of dissociation and/or disaggregation, as well as other functions. Importantly in the embodiments, the mesh (or filters) used herein are not for mechanical, shear, or separation forces. FIG. 2B shows an example of microfluidic channels 1000 that can provide shear flow, transport, and purification of single cells (and clumps during the process) in combination with the flow provided by a pump. In this example, inlet (or continuous junction) 105 is connected with microfluidic flow channel 1010, then junction area 115 leads to microfluidic channel 120, junction 125, microfluidic channel 130, and outlet 135. The dimensions illustrated are in millimeters and can be adjusted, for example, in the range from about 25 nm to about 200 mm, or in the range from about 30 nm to about 100 mm, or in the range from about 40 nm to about 50 mm, or in the range from about 50 nm to about 5 mm. The diagram in FIG. 2B features channels oriented at a thirty degree angle, but a linear configuration (FIG. 3) can be used wherein the different channel iterations are placed in a straight line. The channel dimensions shown in FIG. 2B can be preserved in the new, linear, iteration of the device, however, the channels are oriented in a straight/stretched out manner. Besides this, there are no changes to the design of the channels from this initial prototype in FIG. 2B. In these examples, electrical treatment and acoustics, in addition to shear forces created by controlled microfluidic flow enables the device to dissociate a tissue sample into a purified suspension of single cells.

FIG. 3 provides a perspective view of an embodiment of an Integrated Device 200 of the present technology. A computer with sample-specific programming 900 can optionally be utilized with the pump 65, device 200, or a visualization/sensor/characterization/morphology system 800. Pump 65 delivers shear flow through inlet tubing 215 to inlet 220, while a tissue sample is in well 230 and retained by mesh (201, 202) on either side of the well. The flow has a net sum forward flow to outlet 280. An electrical field is applied at electrical treatment well 230 comprising one or more electrodes 231. Flow provides shear forces and, along with electrical forces, causes clumps of cells and single cells to pass through mesh 202 into microfluidic channel 235 with an optional third mesh 203 therein. Impurities remain in well 230, pass through and are retained around mesh 201, or are further filtered at 203. In one embodiment, the meshes have a smallest at 204. The clumps of cells and single cells pass to acoustic processing region 240 with an acoustic transducer 241 in electrical connection 261 with waveform generator 260. Additional microfluidic channel 245 can be used to connect additional regions. Additional acoustic processing regions 250 and transducers 251 can be used, along with additional meshes. A fourth mesh 204 allows passage of single cells through microfluidic channel 270 to outlet 280 (which can include another mesh/filter). Filtering and disaggregating of clumps of cells and cells is accomplished by mechanical forces, shear flow, mesh, and application of added dissociating forces (such as acoustics), and single cells elute to outlet tubing 290 used for sample collection. It should be understood that the flow can have in totality a forward progression (i.e., from inlet to outlet of the device). However, the terms “inlet” and “outlet” accommodate the back and forth flow. It is important to keep in mind that inlet 220 can inject liquid into the integrated device 200 or can withdraw liquid from the integrated device at the inlet 220. It should be understood that the waveform generator 260 can include electrical connections, WiFi connections, fluidic, mechanical, or electromagnetic connection(s) to any other devices disclosed herein but these are not always illustrated due to complexity.

FIG. 4 provides an expanded view of an embodiment of an Integrated Device 300. The computer 900, pump 65, and visualization/sensor/characterization/morphology system 800 (FIG. 3) can be present in FIG. 4 but are not shown in order to focus on details of the Integrated Device 300. Inlet tubing 215 provides shear flow through inlet to inlet 220, while a tissue sample is in well 230 and retained by mesh (201, 202) on either side of the well. The well 230 can have additional walls 233 to accommodate continuous tissue feed, larger tissue samples, or a combination of samples. An electrical field is applied at electrical treatment well 230 comprising one or more electrodes 231 with electrical connection 232 (which may be more than 1 electrical connection). Flow provides shear forces and, along with electrical forces, causes clumps of cells and single cells to pass through mesh 202 into microfluidic channel 235 with an optional third mesh 203 therein. Impurities remain in well 230, pass through and are retained around mesh 201, or are further filtered at 203. It the should be understood that visualization/sensor/characterization/morphology system 800 can include electrical connections, WiFi connections, fluidic, mechanical, or electromagnetic connection(s) to any other devices disclosed herein but these are not always illustrated due to complexity.

Examining FIG. 4 further, the clumps of cells and single cells pass to acoustic processing region 240 with an acoustic transducer 241 in electrical connection 261 with waveform generator 260. Additional acoustic processing regions 250 and transducers 251 can be used, along with additional meshes. Additional microfluidic channel 245 can be used to connect additional regions/mesh. A fourth mesh 204 allows passage of single cells through microfluidic channel 270 to outlet 280 (which can include another mesh/filter). Filtering and disaggregating of clumps of cells and cells is accomplished by shear flow, mesh, and application of added dissociating forces (such as acoustics), and single cells elute to outlet tubing 290 used for sample collection. It should be understood that the features are illustrated on a PDMS layer, and acrylic channel layer, and an acrylic cover layer (with a glass base or substrate layer at bottom), but the features can be provided in a monolithic structure or on any layer or combination of numbers of layers. For example, the entire device 300 can be on one layer, 2 layers, 3 layers, 4 layers, 5 layers, or in the range from about 5 layers to about 100 layers. It should be clear that the inventive concept described herein is not dependent upon the number(s) of the layers but these are illustrated because the invention is enabled, manufactured, and practiced. With advancement of 3D-printing, it is contemplated that the entire device can comprise a large variety of configurations.

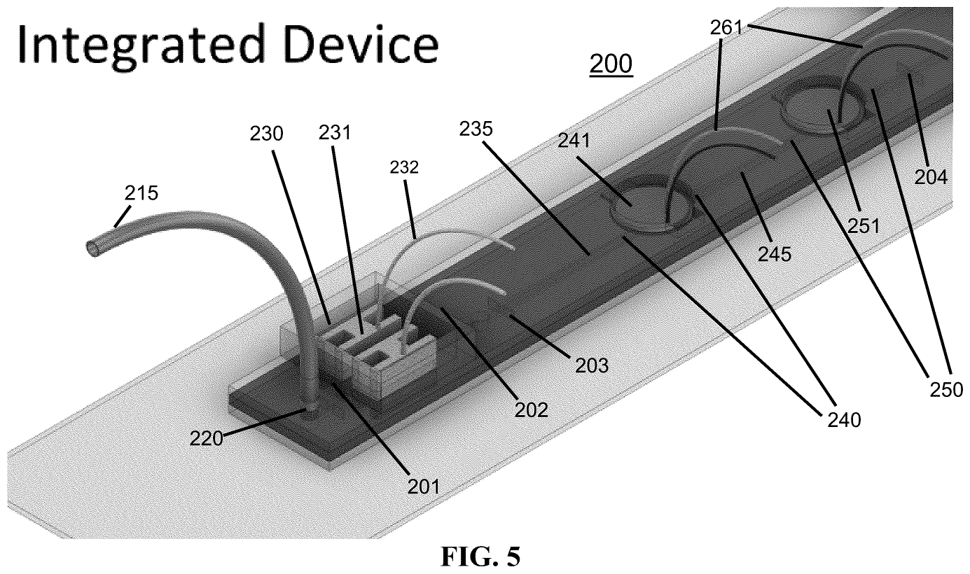

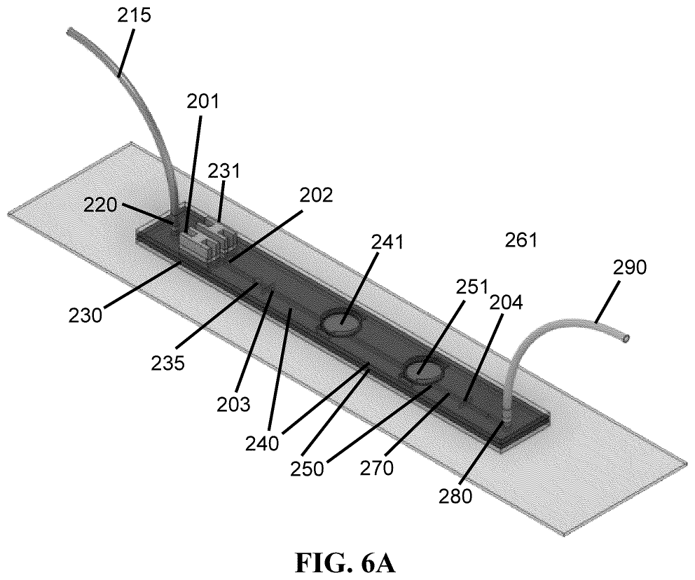

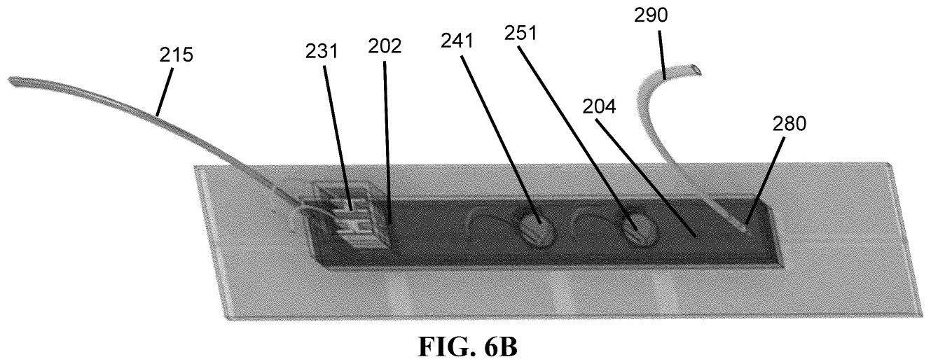

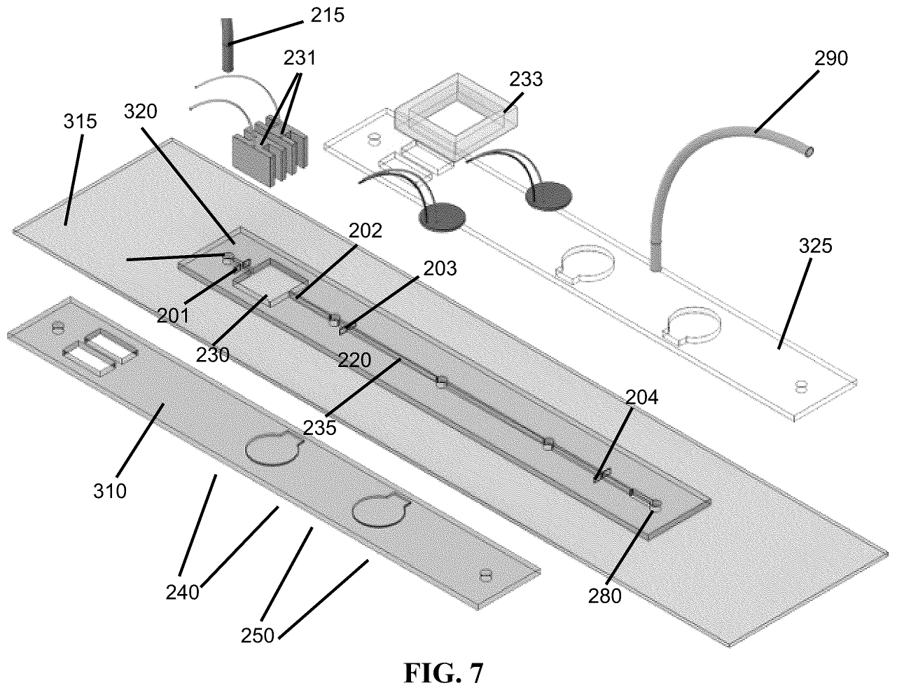

FIG. 5 provides a perspective view of another Integrated Device. FIG. 6A and FIG. 6B provide perspective views of Integrated Devices capable of providing the methods disclosed herein. FIG. 6A shows a representative image of a serially configured device. FIG. 6B shows a top view image of a serially configured device. FIG. 7 provides an expanded view of an Integrated Device to illustrate a tissue input well construct (wall or container) 233 that can take various sizes or can be configured as a tissue inlet for a continuous operation (e.g., continuous feed). According to some aspects, any of the embodiments disclosed herein can include layers or fabrication by combining different layers. For example, a first substrate 310 (e.g., metal or other material) can be fused with a second layer 315 (FIG. 7), optionally a third layer 320, and a fourth layer 325; with each layer including microchannels, mech, cut away wells, acoustic or heat transducers, electrodes, sensors, or any function.

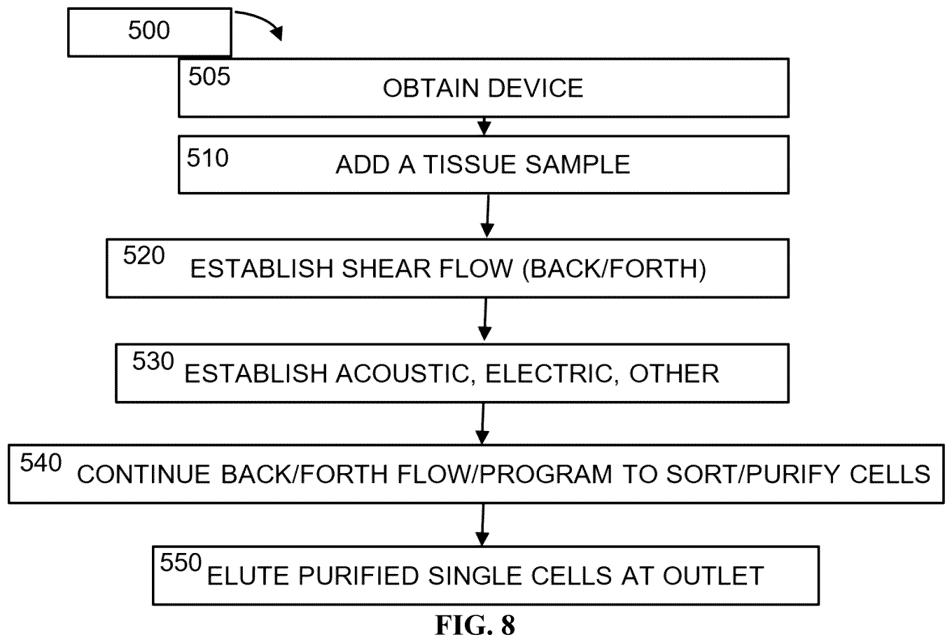

In FIG. 8, a method 500 for preparing a complex tissue sample into single cells for direct single cell analysis (SCA) can comprise the steps of obtaining a device 505 disclosed herein; adding a tissue sample 510; establishing a shear flow 520; establishing electric, acoustic, or other force application to said sample, 530; continuing the back and forth flow to purify and provide single cells 540; and eluting the purified single cells 550. It should be clear that any of the steps 510, 520, 530, 540, and 550 can be claimed in any order, executed in any order, executed partially in any order, left out, repeated, or configured in combinations in any order. A person of skill in the art will see that the inventive concepts in FIG. 8 enable preparing a complex tissue sample into single cells for direct single cell analysis (SCA).

In FIG. 8, a tissue is loaded into the well. In an example, the tissue core is loaded into a 2 mm wide electrical treatment well with electrodes on either side. Perpendicular to these electrodes, nylon mesh is places on both of the two remaining sides in order to prevent the core from being pushing through the chip and facilitate continued dissociation of any remaining larger whereby the device receives flow from the pump from the inlet to the outlet, then the pump repeatedly reverses, and flow is directed from the outlet to the inlet and vice versa, causing a liquid flow with the repeated back and forth flow through the device, thereby eluting purified single cells, suitable for SCA, from the microchannel of the acoustic outlet. Parallel microfluidic flow channels are tested. Nonetheless, the serial configurations (e.g., FIGS. 3-7), work best in the Examples (below).

Importantly, the technology does not require chemical and/or enzymatic buffers. As Implementation and enablement are discussed further in the Examples below. There is no existing technology that implements any feature related to the function of our presently disclosed device. This device is unique in that it integrates acoustic and electrical treatment to accompany the mechanical dissociation from the flow through the chip.

The present innovation, in one of its broadest embodiments (feature A), provides a device for preparing a complex tissue sample into single cells for direct single cell analysis (SCA), the device comprising: a pump capable of providing a shear fluid flow including a forward flow and a reverse flow through the device, in combination with one or more mechanical features to provide shear forces (e.g., chambers, microfluidic channels, changes in liquid flow path), a tissue input well for holding the tissue sample, said well in fluid communication with a first and second mesh positioned adjacent to the inlet; wherein the first mesh is operative to retain the tissue sample in the well when a reverse flow is established, and the second mesh is operative to retain the tissue sample in the tissue input well when a forward flow is established yet allow clumps of cells, cell aggregates, or single cells through the well's outlet; at least one microfluidic channel in fluid communication with the outlet with an optional additional meshes disposed therein the microfluidic channel; an acoustic location in fluid communication with the at least one microfluidic channel, connected to a first acoustic region comprising a high frequency acoustic transducer operative to direct acoustic (sound) waves to clumps of cells in the acoustic region, which comprises a fourth mesh at a first acoustic location in fluid communication with a microchannel; and wherein the device is capable of receiving flow from a pump from the inlet to the outlet, causing a shear liquid flow with the flow through the device, thereby eluting purified single cells, suitable for SCA, from the microchannel of the acoustic outlet. Said acoustic outlet can be connected, for example, to tubing leading to immediate SCA.

In some embodiments, the device of feature A can be wherein the tissue input well comprises one or more electrodes including at least an electrode on a first side of the well and an electrode or ground on a second side of the well. The device can further comprise one or more additional acoustic inlets in fluid communication with the first acoustic region, to provide a series of acoustic regions, each capable of being configured with addition mechanical features, mesh(es), microchannel(s), and second acoustic outlet(s) operative to apply additional acoustic (sound) energy to clumps of cells.

An example of another unique feature of the device is that it requires no chemicals or enzymes, and the eluted single cells can be immediately analyzed without any additional manual or purification steps. Thus, the invention can provide a continuous operation, which is extremely valuable in industrial and clinical settings. As such, the invention can be claimed to be the device/method consisting essentially of a liquid used for transport and the single cells therein, without chemicals and/or enzymes.

The devices disclosed herein can be configured wherein the second, third, fourth mesh, and any additional meshes are configured progressively smaller in mesh size, with the smallest mesh size at an outlet of the device allowing only single cells for SCA to elute from the device.

In some embodiments, the devices disclosed herein can be configured wherein at least one mesh is operative to allow passage of single cells/viruses/particles/proteins in the size from about 1 μm to about 200 μm, in the size from about 5 μm to about 150 μm, or in the size from about 10 μm to about 100 μm. In some embodiments, the larger mesh sizes are operative to purify the single cells for SCA due to the back and forth, forward flow and reverse flow through the device. In some embodiments, smallest mesh sizes are used for purification, depending on impurities present.

In some embodiments, the repeated back and forth flow is operative to prevent clogs in the device. In some embodiments, at least one microfluidic channel includes a change in diameter along a length of the channel, the change operative to provide additional mechanical or shear forces to clumps of cells. In some embodiments, even during continuous operation, an unclogging step can be added at any point in a process. In an unclogging step, a chemical or enzyme flush can be used, but these are not retained in the device/method after operation is resumed.

In some embodiments, the device can be configured wherein an acoustic transducer is operative to provide acoustic (sound) waves in the range from about 40 kHz to about 20 MHz, in the range from about 500 kHz to about 10 MHz, in the range from about 1 MHz to about 8 MHZ, or in the range from about 3 MHz to about 7 MHz. In some embodiments, an acoustic transducer is operative to provide an acoustic (sound) wave at about 5.7 MHz.

In some embodiments, at least one mesh comprises a polymer. In some embodiments, the polymer includes nylon.

In some embodiments, the tissue input well comprises a width in the range from about 100 nm to about 50 mm, from about 500 nm to about 25 mm, from about 1 mm to about 10 mm, from about 1 mm to about 5 mm, or from about 1.5 mm to about 3 mm. In some embodiments, the tissue input well can include a height in the range from about 100 nm to about 5 cm, from about 500 nm to about 1 cm, or about 2 mm to about 100 mm. In some embodiments, the tissue input well can be configured as a continuous inlet for tissue(s).

In some embodiments, a device disclosed herein comprises a pair of electrodes, wherein the pair are capable of providing an electric field through a tissue sample, the electrical field comprising a voltage, current, frequency, field, or a combination thereof. The pair can be more than one pair (e.g., a series).

In some embodiments, the electrical field comprises a DC field, an AC field, a magnetic field, an electromagnetic radiation of any wavelength, a particle, or a combination thereof. In some embodiments, the electrical field comprises about a 20 V, about 1 kHz square wave.

The devices disclosed herein can be operated with the proviso wherein the device is enzyme-free, chemical free, and/or additive free. The unclogging step can be done with no residual trace left after the unclogging.

In some embodiments, the devices disclosed herein can be claimed with cells disposed inside and the device delivering into single cells for SCA, wherein the plurality of purified single cells are >70% viable. In some embodiments, the devices disclosed herein are suitable for providing continuous operation. In some embodiments, the devices disclosed herein are capable of removing red blood cells (and/or cell fragments) from the plurality of purified single cells.

In some embodiments, any one of the devices disclosed herein can be wherein the device is capable of disaggregating cell clumps, purifying the resulting cell suspension, and eluting a plurality of purified single cells suitable for direct analysis via SCS.

In some embodiments, any one of the devices disclosed herein can be wherein the device is capable of providing the plurality of purified single cells in about 1 to about 120 minutes, in about 2 to about 60 minutes, in about 3 to about 30 minutes, or in about 5 to about 20 minutes.

In some embodiments, any one of the devices disclosed herein can be configured wherein the device comprises a base layer, a channel layer, a polydimethylsiloxane (PDMS) layer, and a cover layer; or wherein the device is produced in layers.

In some embodiments, any one of the devices disclosed herein can be wherein a high frequency acoustic transducer is disposed on a cover layer outside a first acoustic region.

In some embodiments, any one of the devices disclosed herein can be with a non-ionic liquid disposed inside. An example of a non-ionic liquid is 18 megaohm water, but in general pure water can be a non-ionic liquid. An example of a non-ionic liquid is 18 megaohm water, but in general pure water can be a non-ionic liquid. In some embodiments, the non-ionic liquid can be a fluid than can include one or more non-ionic liquids and/or additives. In an example, the non-ionic fluid can be ultra-pure H₂O supplemented with isotonic sucrose solution.

In some embodiments, any one of the devices disclosed herein can be further comprising an imaging device operative to form a (visual) image of at least one of a cell, tissue, cell clump, or a flow.

In some embodiments, a method (feature B) for preparing a complex tissue sample into single cells for direct single cell analysis (SCA) is disclosed herein, the method comprising the steps of: 1) obtaining a device of any preceding or following feature; 2) disposing a tissue sample into the tissue input well; 3) establishing an acoustic (sound) energy in the device and at least one of a liquid flow through the device and an electrical field in the device; 4) providing a back and forth, liquid flow including mechanical forces and a forward flow and a reverse flow through the device; whereby the device receives flow from the pump from the inlet to the outlet, then the pump repeatedly reverses, and flow is directed from the outlet to the inlet and vice versa, causing a shear liquid flow with the repeated back and forth flow through the device, thereby eluting purified single cells, suitable for SCA, from the microchannel of the acoustic outlet.

In some embodiments, the method can be wherein an electrical field is applied in the tissue input well. In some embodiments, the method can be wherein one or more additional acoustic inlets in fluid communication with the first acoustic region and are utilized to provide a series of acoustic regions, each configured with addition mesh(es), microchannel(s), and second acoustic outlet(s) operative to apply progressive acoustic (sound) energy to clumps of cells.

In some embodiments, the method can be wherein the second, third, fourth mesh, and additional meshes are configured progressively smaller in mesh size, with the smallest mesh size at an outlet of the device, whereby only single cells for SCA elute from the smallest mesh size/device.

In some embodiments, the method can be wherein the smallest mesh size is at the inlet, to remove impurities, yet the second, third, fourth mesh, and additional meshes are configured progressively smaller in mesh size, with a smaller mesh size at an outlet of the device, whereby only single cells for SCA elute from the smallest mesh size/device.

In some embodiments, the method can be wherein the larger mesh sizes are utilized with the back and forth, forward flow and reverse flow through the device, to purify single cells for SCA.

In some embodiments, the method can be wherein the smaller mesh sizes are utilized with the back and forth, forward flow and reverse flow through the device, to purify single cells for SCA. In this example, the impurities to be removed are smaller than the single cells for SCA.

In some embodiments, the method can be further comprising the step of preventing clogs in the device by using a repeated back and forth flow.

In some embodiments, the method can be further comprising the step of applying at least one additional shear force to a clump of cells, wherein the step includes a change in diameter along a length of microchannel, the change operative to provide additional shear forces to clumps of cells.

In some embodiments, the method can be wherein acoustic (sound) waves are applied in the range from about 40 kHz to about 20 MHz, in the range from about 500 kHz to about 10 MHz, in the range from about 1 MHz to about 8 MHz, or in the range from about 3 MHz to about 7 MHz.

In some embodiments, the method can be wherein acoustic (sound) waves are applied at about 5.7 MHz. In some embodiments, the method can be wherein at least one mesh comprises a polymer, a filter, a screen, or a combination thereof. In some embodiments, the method can be wherein the polymer includes nylon.

In some embodiments, the method can be wherein the tissue sample comprises a width in the range from about 100 nm to about 50 mm, from about 500 nm to about 25 mm, from about 1 mm to about 10 mm, from about 1 mm to about 5 mm, or from about 1.5 mm to about 3 mm.

In some embodiments, the method can be wherein the method comprises applying an electric field through the tissue sample, the electrical field comprising a voltage, current, frequency, field, or a combination thereof. In some embodiments, the method can be wherein the electrical field comprises a DC field, an AC field, a magnetic field, an electromagnetic radiation of any wavelength, a particle, or a combination thereof.

In some embodiments, the method can be wherein the electrical field comprises about a 20 V, about 1 kHz square wave.

In some embodiments, the method can be wherein the method is performed continuously and is capable of providing a continuous operation.

In some embodiments, the method can be wherein the method is sufficient to remove red blood cells (and/or cell fragments) from a plurality of purified single cells.

In some embodiments, the method can be wherein the method is capable of providing disaggregated cell clumps, purifying the resulting cell suspension, and eluting a plurality of purified single cells suitable for direct analysis via SCS;

In some embodiments, the method can be wherein the method is tissue and/or cell specific, using a program developed for a specific tissue and/or cell type; and in some embodiments, the method can be wherein the method is capable of providing the plurality of purified single cells in about 1 to about 120 minutes, in about 2 to about 60 minutes, in about 3 to about 30 minutes, or in about 5 to about 20 minutes.

In some embodiments, the method can be further comprising use of an imaging device operative to form a (visual) image of at least one of a cell, tissue, cell clump, or a flow.

In some embodiments, a method for diagnosing a condition in a subject in need thereof is disclosed herein, the diagnostic method comprising the method of any one of the features herein; wherein: (1) a candidate tissue sample is provided from the subject; (2) cells suitable for SCS are provided by the methods herein; (3) analyzing/detecting at least a single cell from the subject, said single cell indicative of the condition; and (4) reporting a cell type of the single cell. In some embodiments, the diagnostic method can be wherein the analyzing comprises single cell transcriptomics, RNA sequencing (RNA-seq), PCR, fluorescence activated cell soring (FACS), clustering, isolation of the cell, further application of a flowing force, or a combination thereof.

In some embodiments, the diagnostic method can be wherein the candidate tissue is derived from a cancerous tissue, an abnormal tissue, or a tissue infected with a microorganism/virus.

In some embodiments, any of the methods disclosed herein can be executed wherein a tissue-specific, condition-specific, cell-specific, or subject-specific program is utilized in the method.

In some embodiments, a method for designing, screening, and/or locating a therapeutic agent is disclosed herein, said therapeutic agent suitable for preventing and/or treating a subject either in need or for prophylactic treatment. The screening method can be wherein the method is repeated for a plurality of candidate therapeutic agents and a measurement/determination of antagonism or agonism of a receptor of is provided for each of the candidate therapeutic agents. Each of the candidate therapeutic agents can be ranked in comparison to the other each of the candidate therapeutic agents for an efficacy.

Any of the embodiments/devices/methods can be provided in a kit or claimed as a system. The technology contemplates adaptability. In some embodiments, temperature control such as Peltier coolers, liquid nitrogen, or heating units can be placed at any position in the devices and/or methods disclosed herein. The above-described methods can optionally include administering and/or applying a therapeutic agent to a subject. The therapeutic agent can have a potency in any range suitable to provide an effect in a subject in need thereof. The effect can be immediate and readily discernable, for example, by a decrease in symptoms, conditions, or injuries. The effect can be a long-term effect that requires years and/or a statistical significance to discern. The therapeutic agent can be administered in combination with any other drug or therapeutic agent and can have efficacy in the prevention, modulation, treatment, and/or diagnosis. The present invention can be utilized to design therapeutic agents to perform the methods disclosed herein. The therapeutic agents can be delivered alone or can be linked to other agents (e.g., antibody conjugates, liposome formulations, inhaled particles, time-released formulations, micro/nanoparticles). In some embodiments, a targeting moiety can be utilized with the therapeutic agents. In some embodiments, the targeting moiety is an antibody with affinity for a specific type of cell (e.g., a specific type of connective tissue). In another example, the targeting moiety is a nanoparticle. In some embodiments, a formulation or a therapeutic agent can be administered directly to a tissue in need thereof, for example, when an acute injury is treated, by use of a topical (skin penetrating) formulation, or in an emergency. The methods disclosed herein can be utilized to diagnose subjects' risk of being in need of a treatment. The methods can be applied to populations, for example, with artificial intelligence and machine learning, or can be applied to individuals, for example, using personalized medicine.

The technology contemplates zero power devices/method at one end of the spectrum. In this example, ebb and flow of nature (instead of a pump) is used in a deployable, zero-power device. Such a zero-power device can be used for far away detections, etc. At the other end of the spectrum, artificial intelligence and full computing resources are used in the devices and methods. One or more suitable computing systems can be used with the technology disclosed herein. It is plainly contemplated that the methods and devices disclosed herein can be implemented in connection with any suitable computing system, visualization system, and/or statistical system. The computing system can be implemented as or can include a computer device that includes a combination of hardware, software, and firmware that allows the computing device to run an applications layer or otherwise perform various processing tasks. Computing devices can include without limitation personal computers, workstations, servers, laptop computers, tablet computers, mobile devices, wireless devices, smartphones, wearable devices, embedded devices, microprocessor-based devices, microcontroller-based devices, programmable consumer electronics, mini-computers, main frame computers, and the like and combinations thereof.

In some new technology discussions, the technology herein can be discussed by mentioning the following list of features, which can be combined with any figure(s), aspects, or other embodiments disclosed herein: Feature 1: A device for preparing a complex tissue sample into single cells for direct single-cell analysis (SCA), the device comprising: a pump capable of providing a back and forth liquid flow including a forward flow and a reverse flow through the device; a tissue input well for holding the tissue sample, said well in fluid communication with an inlet comprising a first mesh and an outlet comprising a second mesh; wherein the first mesh is operative to retain the tissue sample in the well when a reverse flow is established from the outlet to the inlet, and the second mesh is operative to retain the tissue sample in the input well when a forward flow is established from the inlet to the outlet yet allow clumps of cells, cell aggregates, or single cells through the input well's outlet; at least one microfluidic channel in fluid communication with the outlet with an optional third mesh disposed therein the microfluidic channel; and an acoustic inlet in fluid communication with the at least one microfluidic channel, connected to a first acoustic region comprising a high frequency acoustic transducer operative to direct acoustic (sound) waves to clumps of cells in the acoustic region, which comprises a fourth mesh at a first acoustic outlet in fluid communication with a microchannel; wherein the device is capable of receiving flow from a pump from the inlet to the outlet, then the pump repeatedly reverses, and flow is directed from the outlet to the inlet and vice versa, causing a liquid flow with the repeated back and forth flow through the device, thereby eluting purified single cells, suitable for SCA, from the microchannel of the acoustic outlet.
Feature 2: The device of feature 1, wherein the tissue input well comprises one or more electrodes including at least an electrode on a first side of the well and an optional electrode or ground on a second side of the well.
Feature 3: The device of any preceding feature, further comprising one or more additional acoustic inlets in fluid communication with the first acoustic region, to provide a series of acoustic regions, each capable of being configured with addition mesh(es), microchannel(s), and second acoustic outlet(s) operative to apply additional acoustic (sound) energy to clumps of cells.
Feature 4: The device of any preceding feature, wherein the second, third, fourth mesh, and any additional meshes are configured progressively smaller in mesh size, with the smallest mesh size at an outlet of the device allowing only single cells for SCA to elute from the device; wherein at least one mesh is operative to allow passage of single cells/viruses/particles/proteins in the size from about 1 μm to about 200 μm, in the size from about 5 μm to about 150 μm, or in the size from about 10 μm to about 100 μm.
Feature 5: The device of feature 4, wherein the larger mesh sizes are operative to purify the single cells for SCA due to the back and forth, forward flow and reverse flow through the device.
Feature 6: The device of any preceding feature, wherein the repeated back and forth flow is operative to prevent clogs in the device.
Feature 7: The device of any preceding feature, wherein at least one microfluidic channel includes a change in diameter along a length of the channel, the change operative to provide additional shear forces to clumps of cells.
Feature 8: The device of any preceding feature, wherein an acoustic transducer is operative to provide acoustic (sound) waves in the range from about 40 kHz to about 20 MHz, in the range from about 500 kHz to about 10 MHZ, in the range from about 1 MHz to about 8 MHZ, or in the range from about 3 MHz to about 7 MHz.
Feature 9: The device of feature 8, wherein an acoustic transducer is operative to provide an acoustic (sound) wave at about 5.7 MHz.
Feature 10: The device of any preceding feature, wherein at least one mesh comprises a polymer.
Feature 11: The device of feature 10, wherein the polymer includes nylon.
Feature 12: The device of any preceding feature, wherein the tissue input well comprises a width in the range from about 100 nm to about 50 mm, from about 500 nm to about 25 mm, from about 1 mm to about 10 mm, from about 1 mm to about 5 mm, or from about 1.5 mm to about 3 mm.
Feature 13: The device of feature 2 comprising a pair of electrodes, wherein the pair are capable of providing an electric field through a tissue sample, the electrical field comprising a voltage, current, frequency, field, or a combination thereof.
Feature 14: The device of feature 13, wherein the electrical field comprises a DC field, an AC field, a magnetic field, an electromagnetic radiation of any wavelength, a particle, or a combination thereof.
Feature 15: The device of feature 14, wherein the electrical field comprises about a 20 V, about 1 kHz square wave.
Feature 16: The device of any preceding feature, wherein the pump further comprises a microprocessor, memory, and an executable program operative to provide a sample-specific flow program controlling the flow from the pump and into the inlet.
Feature 17: The device of any preceding feature, with the proviso wherein the device is enzyme-free.
Feature 18: The device of any preceding feature with cells disposed inside and the device delivering into single cells for SCA, wherein the plurality of purified single cells are >70% viable.
Feature 19: The device of any preceding feature suitable for providing continuous operation.
Feature 20: The device of any preceding feature, wherein the device is capable of removing red blood cells from the plurality of purified single cells.
Feature 21: The device of any preceding feature, wherein the device is capable of disaggregating cell clumps, purifying the resulting cell suspension, and eluting a plurality of purified single cells suitable for direct analysis via SCS.
Feature 22: The device of any preceding feature, wherein the device is capable of providing the plurality of purified single cells in about 1 to about 120 minutes, in about 2 to about 60 minutes, in about 3 to about 30 minutes, or in about 5 to about 20 minutes.
Feature 23: The device of any preceding feature, wherein the device comprises a base layer, a channel layer, a polydimethylsiloxane (PDMS) layer, and a cover layer; or wherein the device is produced in layers.
Feature 24: The device of feature 23, wherein a high frequency acoustic transducer is disposed on a cover layer outside a first acoustic region.
Feature 25: The device of any preceding feature with a non-ionic liquid disposed inside.
Feature 26: The device of any preceding feature, further comprising an imaging device operative to form a (visual) image of at least one of a cell, tissue, cell clump, or a flow.
Feature 27: A method for preparing a complex tissue sample into single cells for direct single-cell analysis (SCA), the method comprising the steps of:
   (1) obtaining the device of any preceding feature;
   (2) disposing a tissue sample into the tissue input well;
   (3) establishing an acoustic (sound) energy in the device and at least one of a liquid flow through the device and an electrical field in the device;
(4) providing a back and forth liquid flow including a forward flow and a reverse flow through the device; whereby the device receives flow from the pump from the inlet to the outlet, then the pump repeatedly reverses, and flow is directed from the outlet to the inlet and vice versa, causing a liquid flow with the repeated back and forth flow through the device, thereby eluting purified single cells, suitable for SCA, from the microchannel of the acoustic outlet.
Feature 28: The method of feature 27, wherein an electrical field is applied in the tissue input well.
Feature 29: The method of any one of features 27-28, wherein one or more additional acoustic inlets in fluid communication with the first acoustic region and are utilized to provide a series of acoustic regions, each configured with addition mesh(es), microchannel(s), and second acoustic outlet(s) operative to apply progressive acoustic (sound) energy to clumps of cells.
Feature 30: The method of any one of features 27-29, wherein the second, third, fourth mesh, and additional meshes are configured progressively smaller in mesh size, with the smallest mesh size at an outlet of the device, whereby only single cells for SCA elute from the smallest mesh size/device.
Feature 31: The method of feature 30, wherein the larger mesh sizes are utilized with the back and forth, forward flow and reverse flow through the device, to purify single cells for SCA.
Feature 32: The method of any one of features 27-31, further comprising the step of preventing clogs in the device by using a repeated back and forth flow.
Feature 33: The method of any one of features 27-32, further comprising the step of applying at least one additional shear force to a clump of cells, wherein the step includes a change in diameter along a length of microchannel, the change operative to provide additional shear forces to clumps of cells.
Feature 34: The method of any one of features 27-33, wherein acoustic (sound) waves are applied in the range from about 40 kHz to about 20 MHz, in the range from about 500 kHz to about 10 MHz, in the range from about 1 MHz to about 8 MHz, or in the range from about 3 MHz to about 7 MHz.
Feature 35: The method of feature 34, wherein acoustic (sound) waves are applied at about 5.7 MHz.
Feature 36: The method of any one of features 27-35, wherein at least one mesh comprises a polymer, a filter, a screen, or a combination thereof.
Feature 37: The method of feature 36, wherein the polymer includes nylon.
Feature 38: The method of any one of features 27-37, wherein the tissue sample comprises a width in the range from about 100 nm to about 50 mm, from about 500 nm to about 25 mm, from about 1 mm to about 10 mm, from about 1 mm to about 5 mm, or from about 1.5 mm to about 3 mm.
Feature 39: The method of any one of features 27-38, wherein the method comprises applying an electric field through the tissue sample, the electrical field comprising a voltage, current, frequency, field, or a combination thereof.
Feature 40: The method of feature 39, wherein the electrical field comprises a DC field, an AC field, a magnetic field, an electromagnetic radiation of any wavelength, a particle, or a combination thereof.
Feature 41: The method of feature 40, wherein the electrical field comprises about a 20 V, about 1 kHz square wave.
Feature 42: The method of any one of features 27-41, wherein the method is performed continuously and is capable of providing a continuous operation.
Feature 43: The method of any one of features 27-42, wherein the method is sufficient to remove red blood cells from a plurality of purified single cells.
Feature 44: The method of any one of features 27-43, wherein the method is capable of providing disaggregated cell clumps, purifying the resulting cell suspension, and eluting a plurality of purified single cells suitable for direct analysis via SCS; wherein the method is tissue and/or cell specific, using a program developed for a specific tissue and/or cell type; wherein the method is capable of providing the plurality of purified single cells in about 1 to about 120 minutes, in about 2 to about 60 minutes, in about 3 to about 30 minutes, or in about 5 to about 20 minutes.
Feature 45: The method of any one of features 27-44, further comprising use of an imaging device operative to form a (visual) image of at least one of a cell, tissue, cell clump, or a flow.
Feature 46: A method for diagnosing a condition in a subject in need thereof, the method comprising the method of any one of features 27-45; wherein: (1) a candidate tissue sample is provided from the subject; (2) cells suitable for SCS are provided by the method of any of claims 27-45; (3) analyzing/detecting at least a single cell from the subject, said single cell indicative of the condition; and (4) reporting a cell type of the single cell.
Feature 47: The method of feature 46, wherein the analyzing comprises single-cell transcriptomics, RNA sequencing (RNA-seq), PCR, fluorescence activated cell soring (FACS), clustering, isolation of the cell, further application of a flowing force, or a combination thereof.
Feature 48: The method of feature 46, wherein the candidate tissue is derived from a cancerous tissue, an abnormal tissue, or a tissue infected with a microorganism/virus.
Feature 49: The method of any one of features 27-48, wherein a tissue-specific, condition-specific, cell-specific, or subject-specific program is utilized in the method. Various artificial intelligence (AI) including such things as neural networks, deep learning, machine learning or other algorithms can be utilized, along with the computing system(s) to modify the cell dissociation during the process, to examine (e.g., visualize cells/clumps), and for various other tasks such as identification of single cells of interest.

Processing tasks can be carried out by one or more processors. Various types of processing technology can be used including a single processor or multiple processors, a central processing unit (CPU), multicore processors, parallel processors, or distributed processors. Additional specialized processing resources such as graphics (e.g., a graphics processing unit or GPU), video, multimedia, or mathematical processing capabilities can be provided to perform certain processing tasks. Processing tasks can be implemented with computer-executable instructions, such as application programs or other program modules, executed by the computing device. Application programs and program modules can include routines, subroutines, programs, scripts, drivers, objects, components, data structures, and the like that perform particular tasks or operate on data.

Processors can include one or more logic devices, such as small-scale integrated circuits, programmable logic arrays, programmable logic devices, masked-programmed gate arrays, field programmable gate arrays (FPGAs), application specific integrated circuits (ASICs), and complex programmable logic devices (CPLDs). Logic devices can include, without limitation, arithmetic logic blocks and operators, registers, finite state machines, multiplexers, accumulators, comparators, counters, look-up tables, gates, latches, flip-flops, input and output ports, carry in and carry out ports, and parity generators, and interconnection resources for logic blocks, logic units and logic cells.

The computing device (and any other system used) includes memory or storage, which can be accessed by a system bus or in any other manner. Memory can store control logic, instructions, and/or data. Memory can include transitory memory, such as cache memory, random access memory (RAM), static random-access memory (SRAM), main memory, dynamic random-access memory (DRAM), block random access memory (BRAM), and memristor memory cells. Memory can include storage for firmware or microcode, such as programmable read only memory (PROM) and erasable programmable read only memory (EPROM). Memory can include non-transitory or nonvolatile or persistent memory such as read only memory (ROM), one-time programmable non-volatile memory (OTPNVM), hard disk drives, optical storage devices, compact disc drives, flash drives, floppy disk drives, magnetic tape drives, memory chips, and memristor memory cells. Non-transitory memory can be provided on a removable storage device. A computer-readable medium can include any physical medium that is capable of encoding instructions and/or storing data that can be subsequently used by a processor to implement embodiments of the systems and methods described herein. Physical media can include floppy discs, optical discs, CDs, mini-CDs, DVDs, HD-DVDs, Blu-ray discs, hard drives, tape drives, flash memory, or memory chips. Any other type of tangible, non-transitory storage that can provide instructions and/or data to a processor can be used in the systems and methods described herein.

The computing device can include one or more input/output interfaces for connecting input and output devices to various other components of the computing device. Input and output devices can include, without limitation, keyboards, mice, joysticks, microphones, cameras, webcams, displays, touchscreens, monitors, scanners, speakers, and printers. Interfaces can include universal serial bus (USB) ports, serial ports, parallel ports, game ports, and the like. The technology contemplates interfaces with particle size analysis instrumentation and/or morphology analysis instrumentation. For example, identification of a single cell of interest could be flagged by a difference in morphology of that single cell identified by a morphology analysis instrument.

The computing device can access a network over a network connection that provides the computing device with telecommunications capabilities Network connection enables the computing device to communicate and interact with any combination of remote devices, remote networks, and remote entities via a communications link. The communications link can be any type of communication link including without limitation a wired or wireless link. For example, the network connection can allow the computing device to communicate with remote devices over a network which can be a wired and/or a wireless network, and which can include any combination of intranet, local area networks (LANs), enterprise-wide networks, medium area networks, wide area networks (WANS), virtual private networks (VPNs), the Internet, cellular networks, and the like. Control logic and/or data can be transmitted to and from the computing device via the network connection. The network connection can include a modem, a network interface (such as an Ethernet card), a communication port, a PCMCIA slot and card, or the like to enable transmission to and receipt of data via the communications link. A transceiver can include one or more devices that both transmit and receive signals, whether sharing common circuitry, housing, or a circuit boards, or whether distributed over separated circuitry, housings, or circuit boards, and can include a transmitter-receiver.

The computing device can include a browser and a display that allow a user to browse and view pages or other content served by a web server over the communications link. A web server, sever, and database can be located at the same or at different locations and can be part of the same computing device, different computing devices, or distributed across a network. A data center can be located at a remote location and accessed by the computing device over a network. The computer system can include architecture distributed over one or more networks, such as, for example, a cloud computing architecture. Cloud computing includes without limitation distributed network architectures for providing, for example, software as a service (SaaS).

### Examples

The invention now being generally described, it will be more readily understood by reference to the following examples which are included merely for purposes of illustration of certain aspects and embodiments of the present invention and are not intended to limit the invention.

### Example 1. Processing Tissues to Provide Viable Single Cells

The devices and methods were tested with GBM (glioblastoma) spheroids, bovine liver tissue, and mouse heart, liver, and brain tissue.

Briefly, in this example experiment, tissue is loaded into the well 230 of FIG. 3. In this example, the tissue core is loaded into a 2 mm wide electrical treatment well with electrodes on either side. Perpendicular to these electrodes, nylon mesh 201, 202 is placed on both of the two remaining sides in order to prevent the tissue core from being pushing through the chip and facilitate continued dissociation of any remaining larger aggregates. An electrical treatment can be applied to the sample through the electrodes in place, including a 20 V 1 kHz square wave treatment, which has previously been shown (in previous experiments) to be an effective electrical treatment by our group. Electrical treatment in this well breaks up the tissue section into larger cellular clumps.

Subsequently, a syringe pump delivers a sample-specific program controlling the flow to push the dissociated cell clumps through the channels and a series of micro-mesh barriers such as 203.

Cellular aggregates will continue to move down the chip in flow if they are small enough to pass through the mesh openings. Within the channels, the remaining cell clumps are exposed to shear forces from the tailored microfluidic channel geometries, as well as acoustic forces at 240, 241 and 250, 251 that serve to disaggregate them into single cells. Only single cells are able to pass through the final mesh 204 and be collected in the sample, and the system simultaneously excludes cellular aggregates and purifies the sample solution of components like debris and red blood cells.

The repeated back and forth flow from the pump ensures that there is no clogging in the mesh system. In the acoustic region, high frequency transducers are placed on top of the PDMS layer which seals the top of the acrylic chip. As the transducers vibrate, 5.7 MHz acoustic (sound) waves are applied to the flexible PDMS, which vibrates in turn, producing forces to further separate any remaining small cell clumps or aggregates before they are collected at the outlet.

Bulk cell sequencing tests are often unable to catch rare cells and mutations due to low resolution of data and increased background noise. This is a major pitfall in many applications, including but not limited to cancer diagnostics. Because of this, there has been a pivot to single cell sequencing (SCS) workflows in recent years. SCS is highly desirable because it can get a higher resolution of genetic data from individual cells. In turn, this can help us to better understand and disentangle genetic complexity in tissue.

As previously mentioned, the device represents a major advancement: it is the first instrument that is capable of comprehensive preparation of a tissue for direct single cell analyses (SCA) such as scRNAseq. This means that, in the current framework, when clinicians are trying to prepare cancer tissues for downstream SCS, they must use a complicated and expensive array of inefficient benchtop instruments and take up to several hours to prepare their sample. Even the most advanced devices on the market that are consistently used, including the GentleMACS Dissociator™ (Miltenyi Biotec) and Singulator™ (S2 Genomics) require multiple pieces of lab equipment and manual steps. Unlike these other devices, however, our presently disclosed device doesn't just automate a single step of this complicated workflow. Surprisingly, our device goes beyond just the initial dissociation step: it also disaggregates cell clumps, purifies the cell suspension, and elutes a solution of purified single cells, capable for direct analysis via SCS. The nylon mesh in our device is used merely for filtration. We use physical mechanisms to provide dissociation.

By the point the samples are prepared with conventional workflows, these cells typically do not meet the >70% viability requirements necessary for scRNAseq and other analyses. Ultimately, clinicians and researchers are frequently forced to culture these isolated cells in a time and resource intensive process that can take several days. Needing to culture the cells also reduces the ability to get a true picture of what RNA expression would have been like from that tissue in vivo.

Our integrated device has shown to be the best device, particularly for dissociation of clinically relevant, biopsy-sized tissues, such as those routinely collected for cancer diagnostics. It is low cost, portable, enzyme-free, and time efficient. It can be modified to work with a variety of tissue types and sizes. In experiments, it has already been tested with GBM spheroids, bovine liver tissue, and mouse heart, liver, and brain tissue. With access to this device, companies, clinicians, and research labs can put their trust in a reliable product that would be able to do something that is not available anywhere on the market: prepare samples in a fully automated manner for direct SCS with the touch of a button.

### Example 2. Additional Prototype Testing

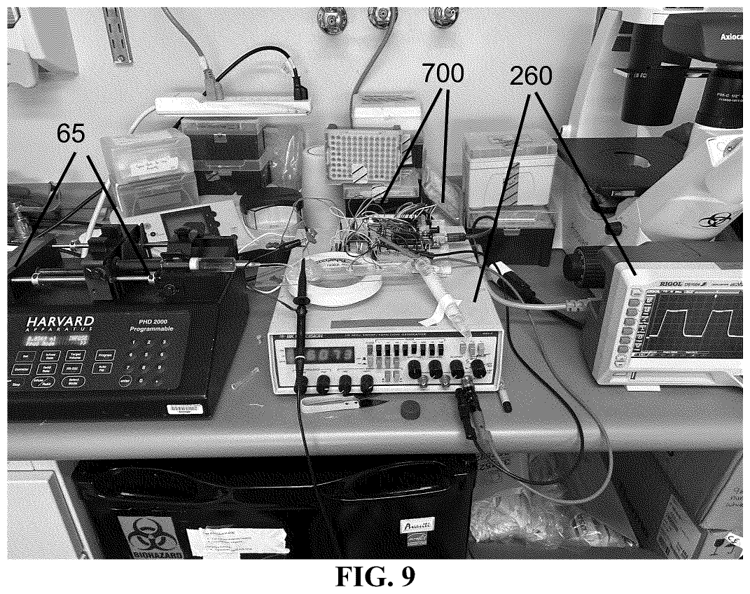

Various prototypes were tested and compared to commercially available instruments. This invention includes functioning prototype(s) of a device for tissue to SCS preparation that could become a product that is sold and used in laboratories across the world, be that in hospitals, clinical labs, academic research labs, diagnostic testing facilities, or companies. FIG. 9 shows a photo of a tested prototype integrated device 700 with waveform generator 260 and pump 65. We have tested the following models in the device: polystyrene particles, triple negative breast cancer cell aggregates, glioblastoma spheroids, bovine liver tissue cores, mouse liver, brain, and heart tissue. The device can be used to dissociate any ex vivo tissues of any organ (e.g., cancer, heart, liver) from any animal (e.g., human, mouse, etc.) or other collections of cells (e.g., in vitro spheroids/organoids/cultured cells, biofilms) into individual component single cells. This itself represents a wide variety of applications in numerous industries and fields.

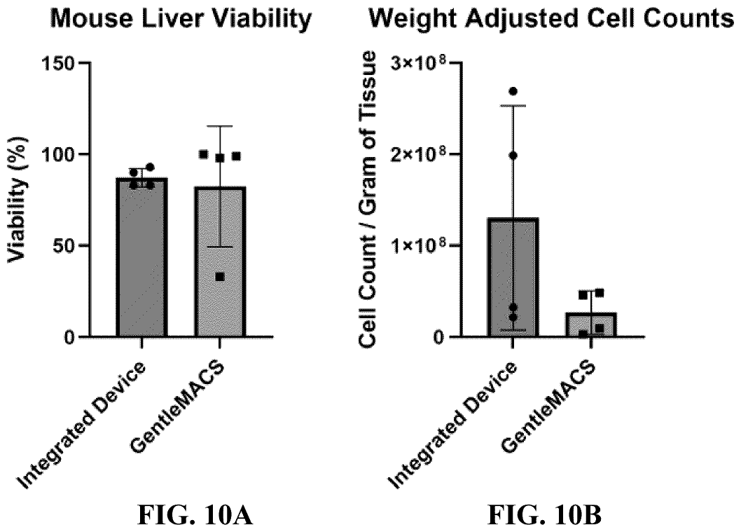

The GentleMACS Dissociator™ is a common product that exists as somewhat of a technology fixture in this way. In labs that work with tissue, you will see one there just as you would see a centrifuge. We envision our technology in a similar position, particularly since it is better and more advanced than any existing devices that currently have this role, fully automated, and precludes the need for multiple manual steps, fragile enzymatic reactions, and multiple expensive reagents and equipment. FIG. 10A and FIG. 10B show comparative data from single cell preparation from tissue using an integrated device of the present disclosure and the commercial device. FIG. 10A shows a comparative plot for Viability (%) for mouse liver. FIG. 10B shows a comparative plot for cell count/gram of tissue (weight adjusted cell counts). Data has been provided simply for the mouse liver tissue to illustrate improved device performance. GentleMACS is a leading industrial competitor, while the integrated device label (FIG. 10A, FIG. 10B) refers to our newly created device.

Methods: The gold standard of tissue core dissociation is the GentleMACS Dissociator™. This is a benchtop instrument for the semi-automated dissociation of tissues into single cells or smaller fragments. This process is expensive due to the equipment and reagents needed to process the tissue, which are on the order of over $1,000 each just for 25 samples. Surprisingly, to process 1,000 samples with the presently disclosed device would still be less costly than a mere 25 samples with this competing product. The GentleMACS preparation takes over 2 hours to complete, while our preparation with this device takes approximately 5-20 minutes, depending on the tissue type. Our device features built-in sample purification and cleanup components, including a filter to remove debris, red blood cells, and other components that abound in GentleMACS prepared samples.

Our integrated device was surprisingly low-cost, streamlined, and effective. It is thought, after operation and comparison, that the most unique aspect of this device is the combined implementation of electrical treatment, filtering, mechanical/shear forces, and acoustics to yield a single suspension with high viability without the use of enzymatic dissociation, which has been known to affect the transcriptional profile of cells. Our treatment, on the other hand, has been shown to be exceptionally gentle on cellular RNA in multiple cell types and formats. Another advantage of our device is its versatility in being able to process tissues from difference organs and species without needed to invest in additional components, unlike the GentleMACS Dissociator, which requires separate reagent kits to be purchased for every organism and tissue, and only works for select tissues and organisms, including mice. Additionally, each of the features in our device can be customized for the type of sample being processed. The devices can be sold as an encapsulated box (in a kit), similarly to the GentleMACS, but, unlike this other product, we would not require the use of any other pieces of lab equipment or reagents.

WO2022/226004A1 came from previous work. No other publications are thought to be relevant to the surprisingly pure single cells obtained herein. Any patents or other publications; including literature references, issued patents, published patent applications, and co-pending patent applications; cited throughout this application are expressly incorporated herein by reference for the purpose of describing and disclosing, for example, the methodologies described in such publications that might be used in connection with the technology described herein. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Broader conceptions are explored; now in descriptions of a prophetic example, a device and method (d) including any feature above or the descriptions below is fabricated and tested: Description 1: A device for preparing a complex tissue sample into single cells for direct single-cell analysis (SCA), the device comprising: a tissue processing device configured to prepare the complex tissue sample into single cells for direct single-cell analysis (SCA) by providing a back and forth liquid flow including a forward flow and a reverse flow through the device, wherein the tissue processing device is configured to elute purified single cells suitable for SCA from a microchannel of an acoustic outlet; a tissue retention system configured to hold the tissue sample, retain the tissue sample in a well when the reverse flow is established from an outlet to an inlet, retain the tissue sample in the well when the forward flow is established from the inlet to the outlet, and allow clumps of cells, cell aggregates, or single cells through the outlet of the well, wherein the well is in fluid communication with the inlet comprising a first mesh and the outlet comprising a second mesh; and an acoustic cell dissociation system operative to direct acoustic waves to clumps of cells in an acoustic region to break down the clumps of cells into single cells.
Description 2: A method for preparing a complex tissue sample into single cells for direct single-cell analysis (SCA), the method comprising:
   providing a back and forth liquid flow including a forward flow and a reverse flow through a device to prepare the complex tissue sample into single cells for direct single-cell analysis (SCA); eluting purified single cells suitable for SCA from a microchannel of an acoustic outlet of the device; holding the tissue sample in a well of the device; retaining the tissue sample in the well when the reverse flow is established from an outlet to an inlet of the well; retaining the tissue sample in the well when the forward flow is established from the inlet to the outlet of the well; allowing clumps of cells, cell aggregates, or single cells through the outlet of the well, wherein the well is in fluid communication with the inlet comprising a first mesh and the outlet comprising a second mesh; and directing acoustic waves to clumps of cells in an acoustic region of the device to break down the clumps of cells into single cells.
Description 3: The device of description 1, wherein the tissue processing device comprises a pump capable of providing the back and forth liquid flow, the pump being configured to repeatedly reverse the flow direction at a predetermined frequency and flow rate to establish the back and forth liquid flow through the device, the predetermined frequency being in the range of about 0.1 Hz to about 10 Hz and the flow rate being in the range of about 1 μL/min to about 1000 μL/min.
Description 4: The device of description 1, wherein the first mesh is operative to retain the tissue sample in the well when the reverse flow is established from the outlet to the inlet, the first mesh having a pore size in the range of about 10 μm to about 100 μm, which is smaller than the tissue sample to prevent the tissue sample from passing through the first mesh while allowing a liquid component of the tissue sample to pass through the first mesh.
Description 5: The device of description 1, wherein the second mesh is operative to retain the tissue sample in the well when the forward flow is established from the inlet to the outlet, the second mesh having a pore size in the range of about 20 μm to about 200 μm, which is larger than the first mesh to allow the clumps of cells, cell aggregates, or single cells to pass through the second mesh while retaining the tissue sample and larger tissue fragments in the well.
Description 6: The device of description 1, further comprising at least one microfluidic channel in fluid communication with the outlet of the well, the at least one microfluidic channel having a cross-sectional dimension in the range of about 10 μm to about 1000 μm and a length in the range of about 1 mm to about 10 cm, the at least one microfluidic channel configured to transport the clumps of cells, cell aggregates, or single cells from the outlet of the well to the acoustic cell dissociation system.
Description 7: The device of description 6, further comprising a third mesh disposed in the at least one microfluidic channel, the third mesh having a pore size in the range of about 5 μm to about 50 μm, which is smaller than the clumps of cells, cell aggregates, or single cells to prevent the clumps of cells, cell aggregates, or single cells from flowing back into the well while allowing the liquid component to flow through the third mesh.
Description 8: The device of description 1, wherein the acoustic cell dissociation system comprises an acoustic inlet in fluid communication with at least one microfluidic channel, the acoustic inlet having a cross-sectional dimension in the range of about 10 μm to about 1000 μm and a length in the range of about 100 μm to about 10 mm, the acoustic inlet connected to the acoustic region, the acoustic inlet configured to introduce the clumps of cells into the acoustic region for cell dissociation.
Description 9: The device of description 8, wherein the acoustic region comprises a high frequency acoustic transducer operative to direct the acoustic waves to the clumps of cells in the acoustic region, the high frequency acoustic transducer having a frequency in the range of about 100 kHz to about 10 MHz and an acoustic power density in the range of about 0.1 W/cm2 to about 100 W/cm2, the acoustic waves having a wavelength in the range of about 0.1 mm to about 10 mm.
Description 10: The device of description 8, further comprising a fourth mesh at the acoustic outlet in fluid communication with the microchannel, the fourth mesh having a pore size in the range of about 1 μm to about 20 μm, which is smaller than the single cells to prevent the single cells from flowing back into the acoustic region while allowing the liquid component to flow through the fourth mesh.
Description 11: The method of description 2, wherein providing the back and forth liquid flow comprises using a pump capable of providing the back and forth liquid flow, the pump being configured to repeatedly reverse the flow direction at a predetermined frequency and flow rate to establish the back and forth liquid flow through the device, the predetermined frequency being in the range of about 0.1 Hz to about 10 Hz and the flow rate being in the range of about 1 μL/min to about 1000 μL/min.
Description 12: The method of description 2, wherein retaining the tissue sample in the well when the reverse flow is established comprises using the first mesh to retain the tissue sample in the well, the first mesh having a pore size in the range of about 10 μm to about 100 μm, which is smaller than the tissue sample to prevent the tissue sample from passing through the first mesh while allowing a liquid component of the tissue sample to pass through the first mesh.
Description 13: The method of description 2, wherein retaining the tissue sample in the well when the forward flow is established comprises using the second mesh to retain the tissue sample in the well, the second mesh having a pore size in the range of about 20 μm to about 200 μm, which is larger than the first mesh to allow the clumps of cells, cell aggregates, or single cells to pass through the second mesh while retaining the tissue sample and larger tissue fragments in the well.
Description 14: The method of description 2, further comprising allowing the clumps of cells, cell aggregates, or single cells to pass through at least one microfluidic channel in fluid communication with the outlet of the well, the at least one microfluidic channel having a cross-sectional dimension in the range of about 10 μm to about 1000 μm and a length in the range of about 1 mm to about 10 cm, the at least one microfluidic channel configured to transport the clumps of cells, cell aggregates, or single cells from the outlet of the well to the acoustic cell dissociation system.
Description 15: The method of description 14, further comprising using a third mesh disposed in the at least one microfluidic channel to retain the tissue sample in the well, the third mesh having a pore size in the range of about 5 μm to about 50 μm, which is smaller than the clumps of cells, cell aggregates, or single cells to prevent the clumps of cells, cell aggregates, or single cells from flowing back into the well while allowing the liquid component to flow through the third mesh.
Description 16: The method of description 2, wherein directing the acoustic waves comprises using an acoustic inlet in fluid communication with at least one microfluidic channel, the acoustic inlet having a cross-sectional dimension in the range of about 10 μm to about 1000 μm and a length in the range of about 100 μm to about 10 mm, the acoustic inlet connected to the acoustic region, the acoustic inlet configured to introduce the clumps of cells into the acoustic region for cell dissociation.
Description 17: The method of description 16, wherein directing the acoustic waves comprises using a high frequency acoustic transducer in the acoustic region to direct the acoustic waves to the clumps of cells in the acoustic region, the high frequency acoustic transducer having a frequency in the range of about 100 kHz to about 10 MHz and an acoustic power density in the range of about 0.1 W/cm2 to about 100 W/cm2, the acoustic waves having a wavelength in the range of about 0.1 mm to about 10 mm.
Description 18: The method of description 16, further comprising using a fourth mesh at the acoustic outlet in fluid communication with the microchannel to retain the tissue sample in the well, the fourth mesh having a pore size in the range of about 1 μm to about 20 μm, which is smaller than the single cells to prevent the single cells from flowing back into the acoustic region while allowing the liquid component to flow through the fourth mesh.
Description 19: The method of description 2, wherein the back and forth liquid flow causes the tissue sample to be repeatedly eluted from the microchannel of the acoustic outlet at a predetermined frequency and flow rate, the predetermined frequency being in the range of about 0.1 Hz to about 10 Hz and the flow rate being in the range of about 1 μL/min to about 1000 μL/min, the repeated elution resulting in an increased yield of purified single cells suitable for direct single-cell analysis (SCA), the increased yield being at least 50% higher than a yield obtained without the repeated elution.
Description 20: The method of description 2, wherein the purified single cells eluted from the microchannel of the acoustic outlet are suitable for direct single-cell analysis (SCA) without further processing, the direct single-cell analysis (SCA) being selected from the group consisting of single-cell genomics, single-cell transcriptomics, single-cell proteomics, and single-cell metabolomics, wherein the purified single cells have a viability of at least 80% and a purity of at least 90% as determined by flow cytometry analysis.

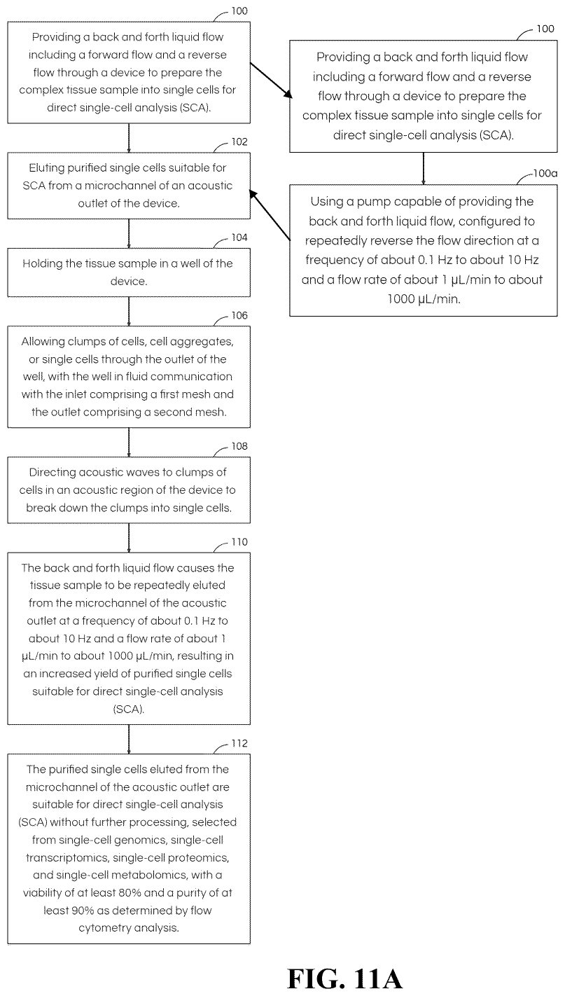

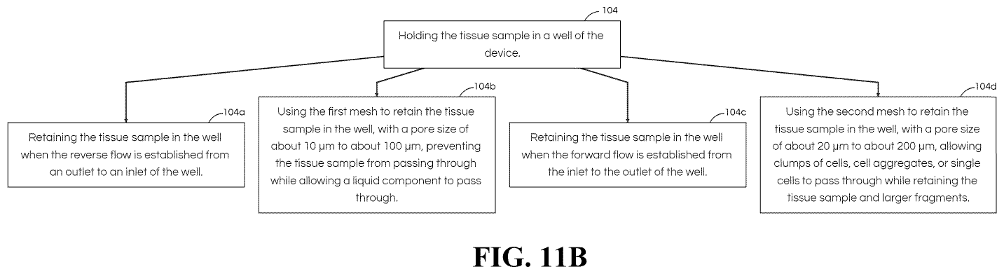

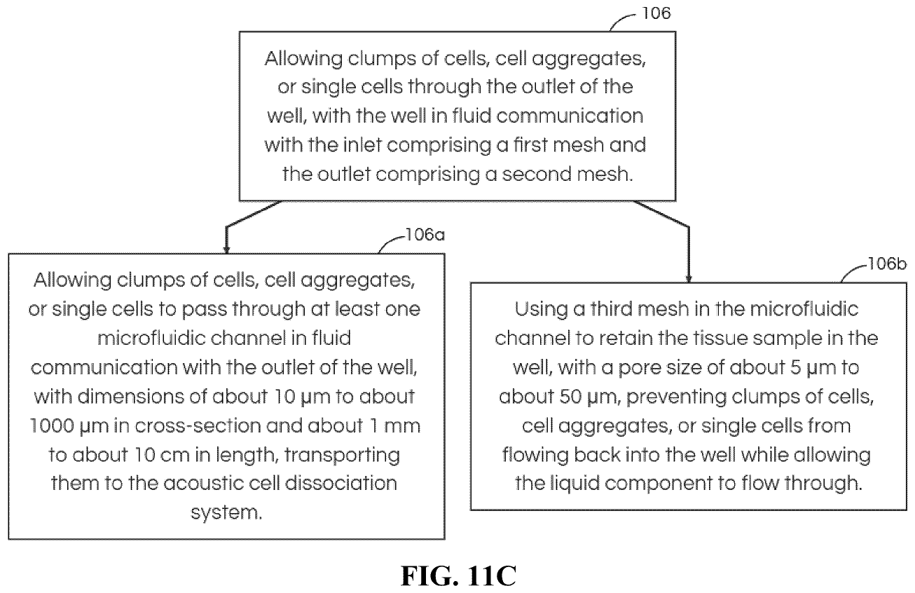

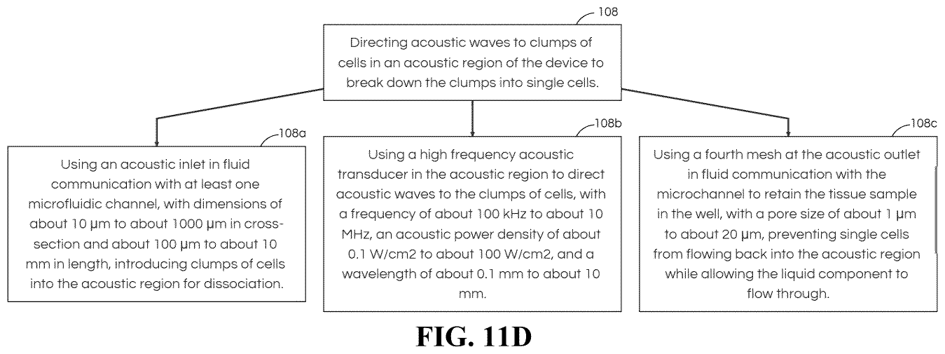

Variations of the methods are tried; examining FIG. 11A, in step 100, the process begins with providing a back and forth liquid flow, including a forward flow and a reverse flow through a device to prepare the complex tissue sample into single cells for direct single-cell analysis (SCA). Sub-step 100-a involves using a pump capable of providing the back and forth liquid flow. The pump is configured to repeatedly reverse the flow direction at a predetermined frequency and flow rate to establish the back and forth liquid flow through the device. The predetermined frequency is in the range of about 0.1 Hz to about 10 Hz, and the flow rate is in the range of about 1 μL/min to about 1000 μL/min. The pump creates this liquid flow, facilitating the movement of the tissue sample and cells through the device.

The device for preparing a complex tissue sample into single cells for direct single-cell analysis (SCA) comprises several components. It includes a pump capable of providing a back and forth liquid flow, including a forward flow and a reverse flow through the device. The tissue input well holds the tissue sample and is in fluid communication with an inlet comprising a first mesh and an outlet comprising a second mesh. The first mesh retains the tissue sample in the well when a reverse flow is established from the outlet to the inlet. The second mesh retains the tissue sample in the input well when a forward flow is established from the inlet to the outlet, yet allows clumps of cells, cell aggregates, or single cells through the input well's outlet. Additionally, the device includes at least one microfluidic channel in fluid communication with the outlet, with an optional third mesh disposed therein the microfluidic channel. An acoustic inlet is in fluid communication with the at least one microfluidic channel, connected to a first acoustic region comprising a high frequency acoustic transducer operative to direct acoustic (sound) waves to clumps of cells in the acoustic region. The device also comprises a fourth mesh at a first acoustic outlet in fluid communication with a microchannel. The pump repeatedly reverses, causing a liquid flow with the repeated back and forth flow through the device, thereby eluting purified single cells suitable for SCA from the microchannel of the acoustic outlet.

During the method, the device prepares a complex tissue sample into single cells for direct single-cell analysis (SCA). The pump provides a back and forth liquid flow through the device, facilitating the movement of the tissue sample and cells. The first mesh retains the tissue sample in the well during reverse flow, while the second mesh retains the tissue sample in the input well during forward flow, allowing clumps of cells, cell aggregates, or single cells to pass through. The microfluidic channel facilitates the flow of cells and may include an optional third mesh for further processing. The acoustic inlet connects the microfluidic channel to the acoustic region for further processing, where the high frequency acoustic transducer directs acoustic waves to clumps of cells for separation and processing. The fourth mesh filters cells at the acoustic outlet before they enter the microchannel.

In summary, step 100 and its sub-step 100-a (FIG. 11A) detail the initial phase of the process, focusing on establishing a back and forth liquid flow through the device using a pump, which is essential for preparing the complex tissue sample into single cells suitable for direct single-cell analysis. In step 102, the process involves eluting purified single cells suitable for single-cell analysis (SCA) from a microchannel of an acoustic outlet of the device. The microchannel is a critical component in this step, as it is configured to elute purified single cells suitable for SCA. The device is designed to prepare a complex tissue sample into single cells for direct single-cell analysis (SCA). The microchannel's purpose is to elute purified single cells suitable for single-cell analysis.

The device comprises a pump capable of providing a back and forth liquid flow, including a forward flow and a reverse flow through the device. This repeated back and forth flow is essential for the elution process. The tissue input well holds the tissue sample and is in fluid communication with an inlet comprising a first mesh and an outlet comprising a second mesh. The first mesh retains the tissue sample in the well when a reverse flow is established from the outlet to the inlet, while the second mesh retains the tissue sample in the input well when a forward flow is established from the inlet to the outlet, allowing clumps of cells, cell aggregates, or single cells to pass through the input well's outlet.

The microchannel, having a cross-sectional dimension in the range of about 10 μm to about 1000 μm and a length in the range of about 1 mm to about 10 cm, is configured to transport the clumps of cells, cell aggregates, or single cells from the outlet of the well to the acoustic cell dissociation system. The acoustic inlet, in fluid communication with the microfluidic channel, introduces the clumps of cells into the acoustic region for cell dissociation. The high frequency acoustic transducer, operative to direct acoustic waves to clumps of cells in the acoustic region, has a frequency in the range of about 100 kHz to about 10 MHz and an acoustic power density in the range of about 0.1 W/cm2 to about 100 W/cm2, with the acoustic waves having a wavelength in the range of about 0.1 mm to about 10 mm.

The fourth mesh at the acoustic outlet, having a pore size in the range of about 1 μm to about 20 μm, prevents the single cells from flowing back into the acoustic region while allowing the liquid component to flow through. This ensures that the purified single cells are eluted from the microchannel of the acoustic outlet, suitable for direct single-cell analysis without further processing. The direct single-cell analysis (SCA) can include single-cell genomics, single-cell transcriptomics, single-cell proteomics, and single-cell metabolomics, with the purified single cells having a viability of at least 80% and a purity of at least 90% as determined by flow cytometry analysis.

In step 104 (e.g., FIG. 11B), the process involves holding the tissue sample in a well of the device. The tissue input well is designed to hold the tissue sample and facilitate its interaction with the first and second meshes. The first mesh retains the tissue sample in the well when a reverse flow is established from the outlet to the inlet. The first mesh has a pore size in the range of about 10 μm to about 100 μm, which is smaller than the tissue sample to prevent the tissue sample from passing through the first mesh while allowing a liquid component of the tissue sample to pass through the first mesh. This ensures that during the reverse flow, the tissue sample remains in the well while the liquid component can pass through.

In sub-step 104-a (FIG. 11B), the tissue sample is retained in the well when the reverse flow is established from an outlet to an inlet of the well. This action is facilitated by the first mesh, which retains the tissue sample in the well during the reverse flow. In sub-step 104-b, the first mesh is used to retain the tissue sample in the well. The first mesh has a pore size in the range of about 10 μm to about 100 μm, which is smaller than the tissue sample to prevent the tissue sample from passing through the first mesh while allowing a liquid component of the tissue sample to pass through the first mesh.

In sub-step 104-c, the tissue sample is retained in the well when the forward flow is established from the inlet to the outlet of the well. This action is facilitated by the second mesh, which retains the tissue sample in the input well during forward flow while allowing clumps of cells, cell aggregates, or single cells to pass through the second mesh. In sub-step 104-d, the second mesh is used to retain the tissue sample in the well. The second mesh has a pore size in the range of about 20 μm to about 200 μm, which is larger than the first mesh to allow the clumps of cells, cell aggregates, or single cells to pass through the second mesh while retaining the tissue sample and larger tissue fragments in the well.

The tissue input well, first mesh, and second mesh work in conjunction to ensure that the tissue sample is held and processed correctly within the device. The first mesh retains the tissue sample during reverse flow, while the second mesh retains the tissue sample during forward flow, allowing the clumps of cells, cell aggregates, or single cells to pass through. This coordinated action ensures that the tissue sample is effectively processed into single cells suitable for direct single-cell analysis (SCA).

In step 106 (e.g., FIG. 11C), the process involves allowing clumps of cells, cell aggregates, or single cells through the outlet of the well. The well is in fluid communication with the inlet comprising a first mesh and the outlet comprising a second mesh. The tissue input well is designed to hold the tissue sample and facilitate its interaction with the first and second meshes. The first mesh retains the tissue sample in the well when a reverse flow is established from the outlet to the inlet, with a pore size in the range of about 10 μm to about 100 μm, which is smaller than the tissue sample to prevent the tissue sample from passing through the first mesh while allowing a liquid component of the tissue sample to pass through the first mesh. The second mesh retains the tissue sample in the input well when a forward flow is established from the inlet to the outlet, with a pore size in the range of about 20 μm to about 200 μm, which is larger than the first mesh to allow the clumps of cells, cell aggregates, or single cells to pass through the second mesh while retaining the tissue sample and larger tissue fragments in the well.

Sub-step 106-a (FIG. 11C) involves allowing the clumps of cells, cell aggregates, or single cells to pass through at least one microfluidic channel in fluid communication with the outlet of the well. The microfluidic channel has a cross-sectional dimension in the range of about 10 μm to about 1000 μm and a length in the range of about 1 mm to about 10 cm. The microfluidic channel is configured to transport the clumps of cells, cell aggregates, or single cells from the outlet of the well to the acoustic cell dissociation system. The microfluidic channel facilitates the flow of cells and potentially includes an optional third mesh for further processing.

Sub-step 106-b involves using a third mesh disposed in the at least one microfluidic channel to retain the tissue sample in the well. The third mesh has a pore size in the range of about 5 μm to about 50 μm, which is smaller than the clumps of cells, cell aggregates, or single cells to prevent the clumps of cells, cell aggregates, or single cells from flowing back into the well while allowing the liquid component to flow through the third mesh. The optional third mesh provides additional filtering or processing within the microfluidic channel.

In step 108 (e.g., FIG. 11D), the process involves directing acoustic waves to clumps of cells in an acoustic region of the device to break down the clumps of cells into single cells. The acoustic region is equipped with a high frequency acoustic transducer, which is specifically designed to direct acoustic waves to the clumps of cells. The high frequency acoustic transducer operates within a frequency range of about 100 kHz to about 10 MHz and an acoustic power density range of about 0.1 W/cm2 to about 100 W/cm2. The acoustic waves generated have a wavelength in the range of about 0.1 mm to about 10 mm. These parameters are critical for the effective dissociation of cell clumps into single cells.

Sub-step 108-a (FIG. 11D) involves using an acoustic inlet that is in fluid communication with at least one microfluidic channel. The acoustic inlet has a cross-sectional dimension in the range of about 10 μm to about 1000 μm and a length in the range of about 100 μm to about 10 mm. The acoustic inlet is configured to introduce the clumps of cells into the acoustic region for cell dissociation. This ensures that the clumps of cells are efficiently directed into the region where the acoustic waves can act upon them.

Sub-step 108-b focuses on the high frequency acoustic transducer within the acoustic region. The transducer directs the acoustic waves to the clumps of cells, facilitating their breakdown into single cells. The specific attributes of the high frequency acoustic transducer, including its frequency, power density, and wavelength, are essential for achieving the desired dissociation.

Sub-step 108-c involves using a fourth mesh at the acoustic outlet, which is in fluid communication with the microchannel. The fourth mesh has a pore size in the range of about 1 μm to about 20 μm, which is smaller than the single cells. This mesh prevents the single cells from flowing back into the acoustic region while allowing the liquid component to flow through. This ensures that the single cells remain in the microchannel for further processing or analysis, maintaining the integrity of the single-cell preparation process.

Overall, step 108 and its sub-steps are integral to the device's function of preparing a complex tissue sample into single cells for direct single-cell analysis. The precise control of acoustic waves and the use of specific mesh sizes ensure that the cells are adequately dissociated and retained for subsequent analysis, highlighting the technical sophistication and effectiveness of the device.

In step 110 (e.g., FIG. 11A), the back and forth liquid flow causes the tissue sample to be repeatedly eluted from the microchannel of the acoustic outlet at a predetermined frequency and flow rate. The predetermined frequency is in the range of about 0.1 Hz to about 10 Hz, and the flow rate is in the range of about 1 μL/min to about 1000 μL/min. This repeated elution results in an increased yield of purified single cells suitable for direct single-cell analysis (SCA). The microchannel is configured to elute purified single cells suitable for SCA from the acoustic outlet. The microchannel elutes purified single cells suitable for single-cell analysis. The device is designed to prepare a complex tissue sample into single cells for direct single-cell analysis (SCA). The device comprises a pump capable of providing a back and forth liquid flow, including a forward flow and a reverse flow through the device. The tissue input well holds the tissue sample and is in fluid communication with an inlet comprising a first mesh and an outlet comprising a second mesh. The first mesh retains the tissue sample in the well when a reverse flow is established from the outlet to the inlet. The second mesh retains the tissue sample in the input well when a forward flow is established from the inlet to the outlet, yet allows clumps of cells, cell aggregates, or single cells through the input well's outlet. At least one microfluidic channel is in fluid communication with the outlet, with an optional third mesh disposed therein the microfluidic channel. An acoustic inlet is in fluid communication with the at least one microfluidic channel, connected to a first acoustic region comprising a high frequency acoustic transducer operative to direct acoustic (sound) waves to clumps of cells in the acoustic region. The device also comprises a fourth mesh at a first acoustic outlet in fluid communication with a microchannel. The device is capable of receiving flow from a pump from the inlet to the outlet, then the pump repeatedly reverses, and flow is directed from the outlet to the inlet and vice versa, causing a liquid flow with the repeated back and forth flow through the device, thereby eluting purified single cells, suitable for SCA, from the microchannel of the acoustic outlet.

In step 112 (FIG. 11A), the focus is on the suitability of the purified single cells eluted from the microchannel of the acoustic outlet for direct single-cell analysis (SCA) without further processing. The direct single-cell analysis (SCA) can be selected from single-cell genomics, single-cell transcriptomics, single-cell proteomics, and single-cell metabolomics. The purified single cells have a viability of at least 80% and a purity of at least 90% as determined by flow cytometry analysis. The device is designed to prepare a complex tissue sample into single cells for direct single-cell analysis (SCA). The device comprises a pump capable of providing a back and forth liquid flow, including a forward flow and a reverse flow through the device. This pump is configured to repeatedly reverse the flow direction at a predetermined frequency and flow rate to establish the back and forth liquid flow through the device. The predetermined frequency is in the range of about 0.1 Hz to about 10 Hz, and the flow rate is in the range of about 1 μL/min to about 1000 μL/min.

The tissue input well holds the tissue sample and is in fluid communication with an inlet comprising a first mesh and an outlet comprising a second mesh. The first mesh retains the tissue sample in the well when a reverse flow is established from the outlet to the inlet. The first mesh has a pore size in the range of about 10 μm to about 100 μm, which is smaller than the tissue sample to prevent the tissue sample from passing through the first mesh while allowing a liquid component of the tissue sample to pass through the first mesh. The second mesh retains the tissue sample in the input well when a forward flow is established from the inlet to the outlet yet allow clumps of cells, cell aggregates, or single cells through the input well's outlet. The second mesh has a pore size in the range of about 20 μm to about 200 μm, which is larger than the first mesh to allow the clumps of cells, cell aggregates, or single cells to pass through the second mesh while retaining the tissue sample and larger tissue fragments in the well.

At least one microfluidic channel is in fluid communication with the outlet of the well, having a cross-sectional dimension in the range of about 10 μm to about 1000 μm and a length in the range of about 1 mm to about 10 cm. This microfluidic channel is configured to transport the clumps of cells, cell aggregates, or single cells from the outlet of the well to the acoustic cell dissociation system. An optional third mesh disposed in the microfluidic channel has a pore size in the range of about 5 μm to about 50 μm, which is smaller than the clumps of cells, cell aggregates, or single cells to prevent the clumps of cells, cell aggregates, or single cells from flowing back into the well while allowing the liquid component to flow through the third mesh.

The acoustic inlet is in fluid communication with the at least one microfluidic channel, having a cross-sectional dimension in the range of about 10 μm to about 1000 μm and a length in the range of about 100 μm to about 10 mm. The acoustic inlet is connected to the acoustic region and is configured to introduce the clumps of cells into the acoustic region for cell dissociation. The high frequency acoustic transducer in the acoustic region directs the acoustic waves to the clumps of cells in the acoustic region. The high frequency acoustic transducer has a frequency in the range of about 100 kHz to about 10 MHz and an acoustic power density in the range of about 0.1 W/cm2 to about 100 W/cm2. The acoustic waves have a wavelength in the range of about 0.1 mm to about 10 mm.

A fourth mesh at the acoustic outlet is in fluid communication with the microchannel. The fourth mesh has a pore size in the range of about 1 μm to about 20 μm, which is smaller than the single cells to prevent the single cells from flowing back into the acoustic region while allowing the liquid component to flow through the fourth mesh.

The back and forth liquid flow causes the tissue sample to be repeatedly eluted from the microchannel of the acoustic outlet at a predetermined frequency and flow rate, resulting in an increased yield of purified single cells suitable for direct single-cell analysis (SCA). The increased yield is at least 50% higher than a yield obtained without the repeated elution. The purified single cells eluted from the microchannel of the acoustic outlet are suitable for direct single-cell analysis (SCA) without further processing, ensuring a viability of at least 80% and a purity of at least 90% as determined by flow cytometry analysis. The foregoing written specification and drawings are considered to be sufficient to enable one skilled in the art to practice the present aspects and embodiments. The present aspects and embodiments are not to be limited in scope by examples provided, since the examples are intended as a single illustration of one aspect and other functionally equivalent embodiments are within the scope of the disclosure. Various modifications in addition to those shown and described herein will become apparent to those skilled in the art from the foregoing description and fall within the scope of the appended claims. The advantages and objects described herein are not necessarily encompassed by each embodiment. Those skilled in the art will recognize or be able to ascertain using no more than routine experimentation, many equivalents to the specific embodiments described herein. Such equivalents are intended to be encompassed by the following claims.

We claim:

1. A device for preparing a complex tissue sample into single cells for direct single-cell analysis (SCA), the device comprising:
a pump capable of providing a back and forth liquid flow including a forward flow and a reverse flow through the device;
a tissue input well for holding the tissue sample, said well in fluid communication with an inlet comprising a first mesh and an outlet comprising a second mesh; wherein the first mesh is operative to retain the tissue sample in the well when a reverse flow is established from the outlet to the inlet, and the second mesh is operative to retain the tissue sample in the input well when a forward flow is established from the inlet to the outlet yet allow clumps of cells, cell aggregates, or single cells through the input well's outlet;
at least one microfluidic channel in fluid communication with the outlet with an optional third mesh disposed therein the microfluidic channel; and
an acoustic inlet in fluid communication with the at least one microfluidic channel, connected to a first acoustic region comprising a high frequency acoustic transducer operative to direct acoustic (sound) waves to clumps of cells in the acoustic region, which comprises a fourth mesh at a first acoustic outlet in fluid communication with a microchannel;
wherein the device is capable of receiving flow from a pump from the inlet to the outlet, then the pump repeatedly reverses, and flow is directed from the outlet to the inlet and vice versa, causing a liquid flow with the repeated back and forth flow through the device, thereby eluting purified single cells, suitable for SCA, from the microchannel of the acoustic outlet.

2. The device of claim 1, wherein the tissue input well comprises one or more electrodes including at least an electrode on a first side of the well and an optional electrode or ground on a second side of the well.

3. The device of claim 1, further comprising one or more additional acoustic inlets in fluid communication with the first acoustic region, to provide a series of acoustic regions, each capable of being configured with addition mesh(es), microchannel(s), and second acoustic outlet(s) operative to apply additional acoustic (sound) energy to clumps of cells.

4. The device of claim 1, wherein the second, third, fourth mesh, and any additional meshes are configured progressively smaller in mesh size, with the smallest mesh size at an outlet of the device allowing only single cells for SCA to elute from the device;
wherein at least one mesh is operative to allow passage of single cells/viruses/particles/proteins in the size from about 1 μm to about 200 μm, in the size from about 5 μm to about 150 μm, or in the size from about 10 μm to about 100 μm.

5. The device of claim 1, wherein the repeated back and forth flow is operative to prevent clogs in the device.

6. The device of claim 1, wherein an acoustic transducer is operative to provide acoustic (sound) waves in the range from about 40 kHz to about 20 MHz, in the range from about 500 kHz to about 10 MHz, in the range from about 1 MHz to about 8 MHz, or in the range from about 3 MHz to about 7 MHz, or at about 5.7 MHz.

7. The device of claim 1, further comprising a pair of electrodes, wherein the pair are capable of providing an electric field through a tissue sample, the electrical field comprising a voltage, current, frequency, field, or a combination thereof; wherein the electrical field comprises a DC field, an AC field, a magnetic field, an electromagnetic radiation of any wavelength, a particle, or a combination thereof; and/or wherein the electrical field comprises about a 20 V, about 1 kHz square wave.

8. The device of claim 1, with the proviso wherein the device is enzyme-free; and with cells disposed inside and the device delivering into single cells for SCA, wherein the plurality of purified single cells are ≥70% viable; and wherein the device is suitable for providing continuous operation.

9. The device of claim 1, wherein the device is capable of removing red blood cells from the plurality of purified single cells.

10. A method for preparing a complex tissue sample into single cells for direct single-cell analysis (SCA), the method comprising the steps of:
(1) obtaining a device comprising:
a pump capable of providing a back and forth liquid flow including a forward flow and a reverse flow through the device;
a tissue input well for holding the tissue sample, said well in fluid communication with an inlet comprising a first mesh and an outlet comprising a second mesh; wherein the first mesh is operative to retain the tissue sample in the well when a reverse flow is established from the outlet to the inlet, and the second mesh is operative to retain the tissue sample in the input well when a forward flow is established from the inlet to the outlet yet allow clumps of cells, cell aggregates, or single cells through the input well's outlet;
at least one microfluidic channel in fluid communication with the outlet with an optional third mesh disposed therein the microfluidic channel; and
an acoustic inlet in fluid communication with the at least one microfluidic channel, connected to a first acoustic region comprising a high frequency acoustic transducer operative to direct acoustic (sound) waves to clumps of cells in the acoustic region, which comprises a fourth mesh at a first acoustic outlet in fluid communication with a microchannel;
wherein the device is capable of receiving flow from a pump from the inlet to the outlet, then the pump repeatedly reverses, and flow is directed from the outlet to the inlet and vice versa, causing a liquid flow with the repeated back and forth flow through the device, thereby eluting purified single cells, suitable for SCA, from the microchannel of the acoustic outlet;
(2) disposing a tissue sample into the tissue input well;
(3) establishing an acoustic (sound) energy in the device and at least one of a liquid flow through the device and an electrical field in the device;
(4) providing a back and forth liquid flow including a forward flow and a reverse flow through the device;
whereby the device receives flow from the pump from the inlet to the outlet, then the pump repeatedly reverses, and flow is directed from the outlet to the inlet and vice versa, causing a liquid flow with the repeated back and forth flow through the device, thereby eluting purified single cells, suitable for SCA, from the microchannel of the acoustic outlet.

11. The method of claim 10, wherein an electrical field is applied in the tissue input well.

12. The method of claim 10, wherein one or more additional acoustic inlets in fluid communication with the first acoustic region and are utilized to provide a series of acoustic regions, each configured with addition mesh(es), microchannel(s), and second acoustic outlet(s) operative to apply progressive acoustic (sound) energy to clumps of cells.

13. The method of claim 10, wherein the second, third, fourth mesh, and additional meshes are configured progressively smaller in mesh size, with the smallest mesh size at an outlet of the device, whereby only single cells for SCA elute from the smallest mesh size/device.

14. The method of claim 10, wherein the larger mesh sizes are utilized with the back and forth, forward flow and reverse flow through the device, to purify single cells for SCA.

15. The method of claim 10, wherein acoustic (sound) waves are applied in the range from about 40 kHz to about 20 MHz, in the range from about 500 kHz to about 10 MHz, in the range from about 1 MHz to about 8 MHz, or in the range from about 3 MHz to about 7 MHz, or at about 5.7 MHz.

16. A method for diagnosing a condition in a subject in need thereof, the method comprising the steps of:
(1) obtaining a device comprising:
a pump capable of providing a back and forth liquid flow including a forward flow and a reverse flow through the device;
a tissue input well for holding the tissue sample, said well in fluid communication with an inlet comprising a first mesh and an outlet comprising a second mesh; wherein the first mesh is operative to retain the tissue sample in the well when a reverse flow is established from the outlet to the inlet, and the second mesh is operative to retain the tissue sample in the input well when a forward flow is established from the inlet to the outlet yet allow clumps of cells, cell aggregates, or single cells through the input well's outlet;
at least one microfluidic channel in fluid communication with the outlet with an optional third mesh disposed therein the microfluidic channel; and
an acoustic inlet in fluid communication with the at least one microfluidic channel, connected to a first acoustic region comprising a high frequency acoustic transducer operative to direct acoustic (sound) waves to clumps of cells in the acoustic region, which comprises a fourth mesh at a first acoustic outlet in fluid communication with a microchannel;
wherein the device is capable of receiving flow from a pump from the inlet to the outlet, then the pump repeatedly reverses, and flow is directed from the outlet to the inlet and vice versa, causing a liquid flow with the repeated back and forth flow through the device, thereby eluting purified single cells, suitable for SCA, from the microchannel of the acoustic outlet;
(2) disposing a tissue sample into the tissue input well;
(3) establishing an acoustic (sound) energy in the device and at least one of a liquid flow through the device and an electrical field in the device;
(4) providing a back and forth liquid flow including a forward flow and a reverse flow through the device;
whereby the device receives flow from the pump from the inlet to the outlet, then the pump repeatedly reverses, and flow is directed from the outlet to the inlet and vice versa, causing a liquid flow with the repeated back and forth flow through the device, thereby eluting purified single cells, suitable for SCA, from the microchannel of the acoustic outlet; and comprising the steps of:
(A) a candidate tissue sample is provided from the subject;
(B) cells suitable for SCS are provided by the method of steps (1)-(4) above;
(C) analyzing/detecting at least a single cell from the subject, said single cell indicative of the condition; and
(D) reporting a cell type of the single cell;
whereby the cell type reported is indicative of or diagnostic of a condition of the subject.

17. The method of claim 16, wherein the analyzing comprises single-cell transcriptomics, RNA sequencing (RNA-seq), PCR, fluorescence activated cell soring (FACS), clustering, isolation of the cell, further application of a flowing force, or a combination thereof.

18. The method of claim 16, wherein the candidate tissue is derived from a cancerous tissue, an abnormal tissue, or a tissue infected with a microorganism/virus.

19. The method of claim 16, wherein a tissue-specific, condition-specific, cell-specific, or subject-specific program is utilized in the method.

20. The method of claim 16, further comprising an analysis by a machine learning algorithm that is trained by one or more historical data from a prior execution of claim 16.
